(19) United States
(12) Patent Application Publication
(10) Pub. No.: US 2026/0065425 A1
(43) Pub. Date: Mar. 5, 2026

(54) GENERATIVE OBJECT COMPOSITING BY LEARNING IDENTITY-PRESERVING REPRESENTATION

(71) Applicant: ADOBE INC., SAN JOSE, CA (US)

(72) Inventors: Yizhi Song, West Lafayette, IN (US); Zhifei Zhang, San Jose, CA (US); Zhe Lin, Clyde Hill, WA (US); Jianming Zhang, Cupertino, CA (US); Scott Cohen, Cupertino, CA (US); Brian Price, Pleasant Grove, UT (US); Soo Ye Kim, San Jose, CA (US); He Zhang, San Jose, CA (US); Wei Xiong, San Jose, CA (US)

(21) Appl. No.: 18/821,013

(22) Filed: Aug. 30, 2024

(51) Int. Cl. G06T 5/50; G06T 5/70; G06T 7/194; G06T 9/00

(52) U.S. Cl. CPC G06T 5/50; G06T 5/70; G06T 7/194; G06T 9/00; G06T 2207/20081; G06T 2207/20221

(57) ABSTRACT

A method, apparatus, non-transitory computer readable medium, and system for image generation include obtaining a foreground image and a background image. The foreground image depicts an object and the background image depicts a scene. The foreground image is encoded, using an image encoder of an image generation model, to obtain a foreground embedding. The foreground embedding preserves the identity of the object. A composite image is generated, using the image generation model, based on the background image and the foreground embedding. The composite image depicts the object from the foreground image within the scene from the background image.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Generative image compositing, a subfield of image processing, involves the use of diffusion models to synthesize composite images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation and compositing. Embodiments of the present disclosure include an image generation apparatus that receives a foreground image and a background image as inputs. The foreground image depicts an object and the background image depicts a scene. The image generation apparatus generates a composite image based on the foreground image and the background image. During training, a two-stage training process involves a first training stage and a second training stage, which may also be referred to as a context-agnostic identity-preserving stage and an object compositing stage, respectively. The first training stage involves taking pairs of foreground objects having different orientation (e.g., view, pose) and training an image encoder of an image generation model to encode the foreground image to obtain an (identity-preserving) foreground embedding. The second training stage involves training a diffusion model that takes the (identity-preserving) foreground embedding as input (from the first stage) and blends a foreground object into a background image. In some cases, a masked region of the background image or an input mask is provided to indicate a location and a scale for object composition.

A method, apparatus, and non-transitory computer readable medium for image processing are described. One or more embodiments of the method, apparatus, and non-transitory computer readable medium include obtaining a foreground image and a background image, wherein the foreground image depicts an object and the background image depicts a scene; encoding, using an image encoder of an image generation model, the foreground image to obtain a foreground embedding, wherein the foreground embedding preserves an identity of the object; and generating, using the image generation model, a composite image based on the background image and the foreground embedding, wherein the composite image depicts the object from the foreground image within the scene from the background image.

A method, apparatus, and non-transitory computer readable medium for image processing are described. One or more embodiments of the method, apparatus, and non-transitory computer readable medium include obtaining a first training set including a first training image and a second training image, wherein the second training image depicts an object from the first training image in a different view; training, using the first training set during a first training stage, an image generation model to generate a synthetic image that preserves an identity and changes an orientation of an object from an input image; obtaining a second training set including a training foreground image, a training background image, and a ground-truth composite image that depicts an object from the training foreground image in a scene from the training background image; and training, using the second training set during a second training stage, the image generation model to generate a composite image based on an input foreground image and an input background image, wherein the composite image depicts an object from the input foreground image in a scene from the input background image.

An apparatus and method for image processing are described. One or more embodiments of the apparatus and method include at least one processor; at least one memory including instructions executable by the at least one processor; and an image generation model comprising parameters stored in the at least one memory and trained to encode a foreground image to obtain a foreground embedding that preserves an identity of an object in the foreground image and generate a composite image based on a background image and the foreground embedding, wherein the composite image depicts the object from the foreground image within a scene from the background image.

### BRIEF DESCRIPTION OF THE DRAWINGS

FIG. 1 shows an example of an image generation system according to aspects of the present disclosure.

FIG. 2 shows an example of a method for conditional media generation according to aspects of the present disclosure.

FIGS. 3 through 5 show examples of generated composite images according to aspects of the present disclosure.

FIG. 6 shows an example of shape-guided generation and shape control effect according to aspects of the present disclosure.

FIGS. 7 and 8 show examples of generated composite images according to aspects of the present disclosure.

FIG. 9 shows an example of a method for image processing and object composition according to aspects of the present disclosure.

FIG. 10 shows an example of an image generation apparatus according to aspects of the present disclosure.

FIGS. 11 and 12 show examples of an image generation model according to aspects of the present disclosure.

FIG. 13 shows an example of background blending process according to aspects of the present disclosure.

FIGS. 14 and 15 show examples of an image generation model according to aspects of the present disclosure.

FIG. 16 shows an example of image compositing based on input masks according to aspects of the present disclosure.

FIG. 17 shows an example of a guided latent diffusion model according to aspects of the present disclosure.

FIG. 18 shows an example of a U-Net architecture according to aspects of the present disclosure.

FIG. 19 shows an example of a diffusion process according to aspects of the present disclosure.

FIG. 20 shows an example of a method for training an image generation model according to aspects of the present disclosure.

FIG. 21 shows an example of a method for training an image generation model based on an identity preserving loss according to aspects of the present disclosure.

FIG. 22 shows an example of a method for training an image generation model based on a compositing loss according to aspects of the present disclosure.

FIG. 23 shows an example of a method for training a diffusion model according to aspects of the present disclosure.

FIG. 24 shows an example of a step-by-step procedure for training a machine learning model according to aspects of the present disclosure.

FIG. 25 shows an example of a data augmentation process according to aspects of the present disclosure.

FIG. 26 shows an example of data curation and view pose adjustment according to aspects of the present disclosure.

FIG. 27 shows an example of an ablation study on a two-stage training process according to aspects of the present disclosure.

FIG. 28 shows an example of a computing device for image processing according to aspects of the present disclosure.

### DETAILED DESCRIPTION

The present disclosure describes systems and methods for image generation and compositing. Embodiments of the present disclosure include an image generation apparatus that receives a foreground image and a background image as inputs. The foreground image depicts an object and the background image depicts a scene. The image generation apparatus generates a composite image based on the foreground image and the background image. During training, a two-stage training process involves a first training stage and a second training stage, which may also be referred to as a context-agnostic identity-preserving stage and an object compositing stage, respectively. The first training stage involves taking pairs of foreground objects having different orientation (e.g., view, pose) and training an image encoder of an image generation model to encode the foreground image to obtain an (identity-preserving) foreground embedding. The second training stage involves training a diffusion model that takes the (identity-preserving) foreground embedding as input (from the first stage) and blends a foreground object into a background image. In some cases, a masked region of the background image or an input mask is provided to indicate a location and a scale for object composition.

Image compositing is an image generation sub-field in which an object depicted in an image is merged with a background image with a goal of creating a new image that realistically incorporates the object with the background image. Conventional image generation techniques often employ many sub-processes (such as geometric correction, image harmonization, image matting, color harmonization, relighting, and shadow generation) to generate a composite image that naturally blends the object into the background image.

Diffusion models are a class of generative neural networks that can be trained to generate new data with features similar to features found in training data. Diffusion models can be used in image synthesis, image compositing tasks, etc. Conventional models focus on color and lighting consistency such as image harmonization and image blending and fail to address geometric adjustments and identity preservation. These models lack the ability to preserve a target object's identity and generate a seamless composite image maintaining visual consistency, geometry and color harmonization.

Embodiments of the present disclosure include an image generation model configured to obtain a foreground image and a background image. The foreground image depicts an object and the background image depicts a scene. In some cases, the background image includes a masked region indicating a location and a scale for the object. In some other cases, the image generation model obtains an input mask indicating the location of the object in the scene. The composite image is generated based on the masked region or the input mask.

In an embodiment, an image encoder of the image generation model encodes the foreground image to obtain a foreground embedding. The foreground embedding preserves an identity of the object from the foreground image. The image generation model generates a composite image based on the background image and the foreground embedding. The composite image depicts the object from the foreground image within the scene from the background image.

During training, the image encoder is trained to preserve an object's identity during a first training stage. The image encoder and a decoder of the image generation model (e.g., decoder blocks of a diffusion U-Net) are trained to combine images during a second training stage. Some embodiments of the present disclosure train the image generation model using a two-stage training process that separates image compositing into a first training stage (identity preservation stage) and a second training stage (background alignment stage).

At the first training stage, an image encoder is trained on multi-view object pairs to learn to generate a (view-invariant identity-preserving) foreground embedding. In some examples, the image encoder includes a base encoder (e.g., DINO encoder as backbone) and a content adapter. At the second stage, the image generation model learns object compositing by taking the trained image encoder from the first training stage and freezing its base encoder backbone. The image encoder generates an (identity-preserving) foreground embedding based on a foreground image. A diffusion model is trained for compositing the object to the masked region. An encoder layer and a decoder layer of the diffusion model are trained during the second training stage. The content adapter of the image encoder is also trained during the second training stage.

At inference, the image generation model generates a composite image that is visually coherent and natural. The composited object in the composite image retains the identity of the foreground object (i.e., target object), aligns to the geometry of the background image, and blends seamlessly into the background.

The present disclosure describes systems and methods that improve on conventional image generation models by generating composite images that depict a target object more accurately. For example, users can obtain composite images with an object that is similar to the identity of a target object from a foreground image. Embodiments of the present disclosure achieve this improved accuracy by dividing training into a first training stage (identity preservation) and a second training stage (background alignment). The first training stage relates to context-agnostic identity-preserving training, where an image encoder is trained to learn view-invariant features, crucial for detail engraving. The second training stage focuses on harmonizing the object with the background, using the robust identity-preserving representation learned from the first training stage. The bifurcation of training schemes increases fidelity in object detail while improving color and geometry harmonization. Accordingly, the quality and accuracy of composite images are improved due to enhanced identity preservation and compositing alignment.

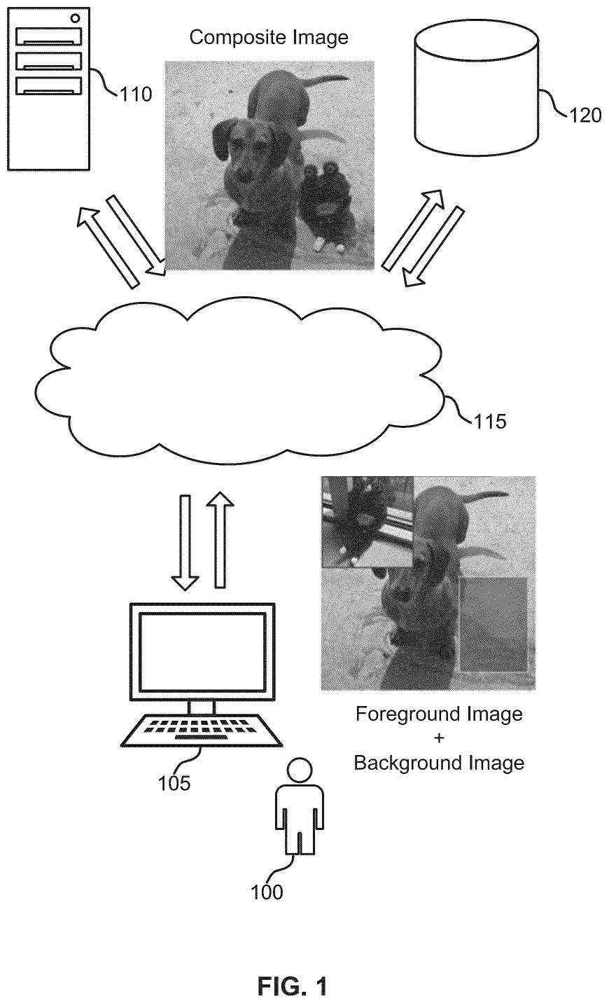

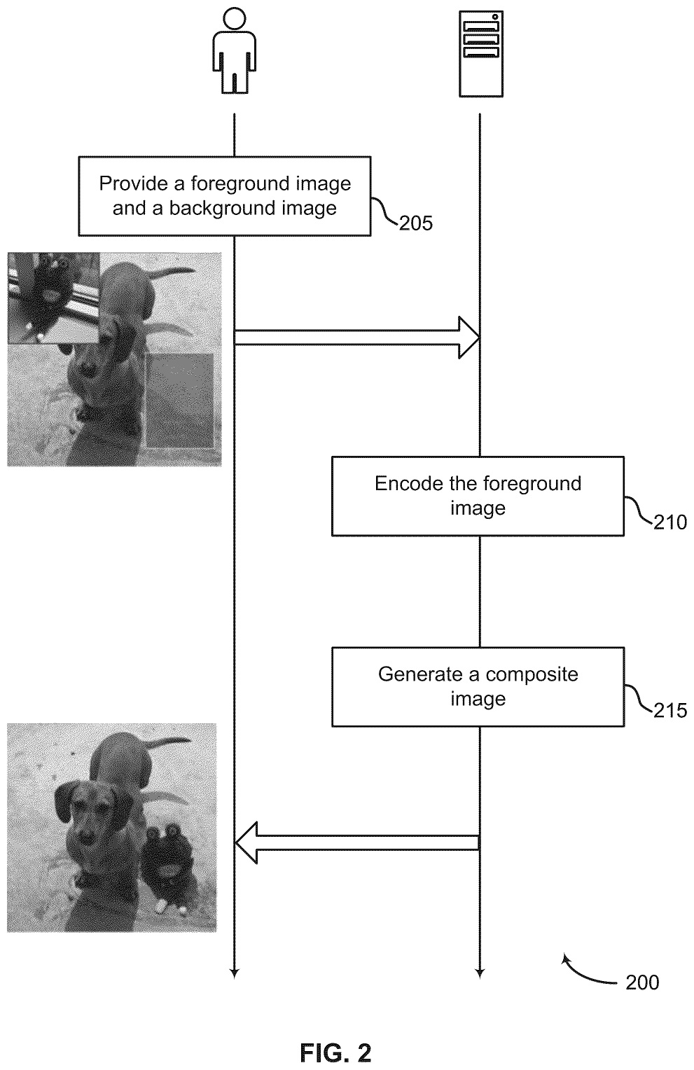

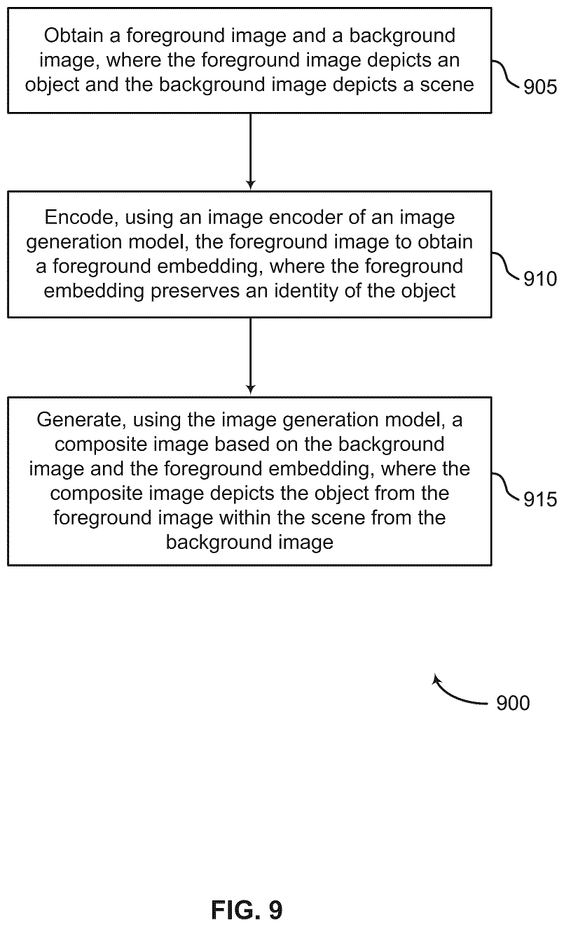

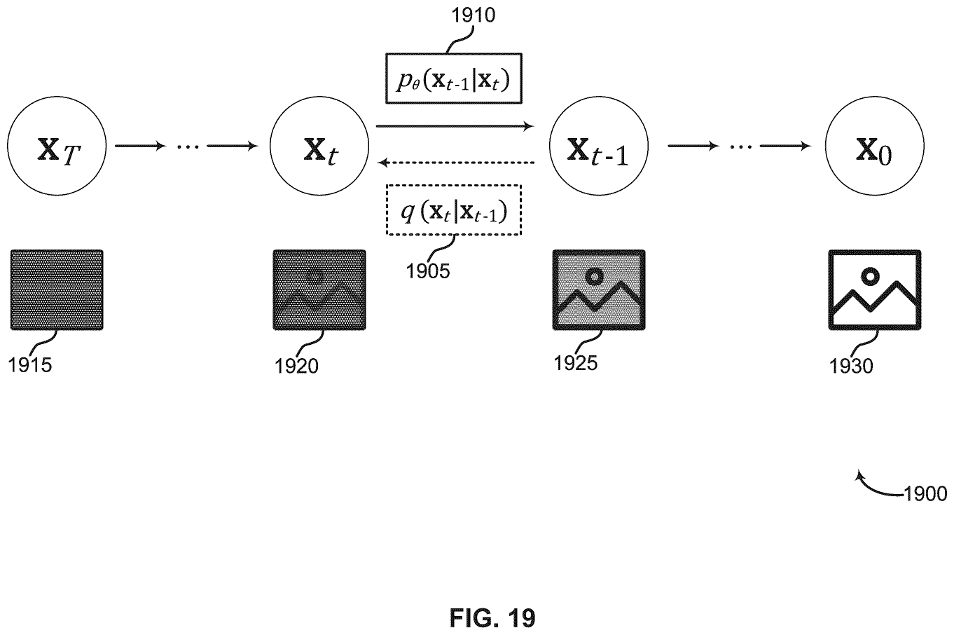

Examples of application in generative object compositing context are provided with reference to FIGS. 2-8. Details regarding the architecture of an example image generation system are provided with reference to FIGS. 1 and 10-18. Details regarding the image generation process are provided with reference to FIGS. 9 and 19. Details regarding examples of training an image generation model for object compositing are provided with reference to FIGs. and 20-24.

### Image Generation and Object Compositing

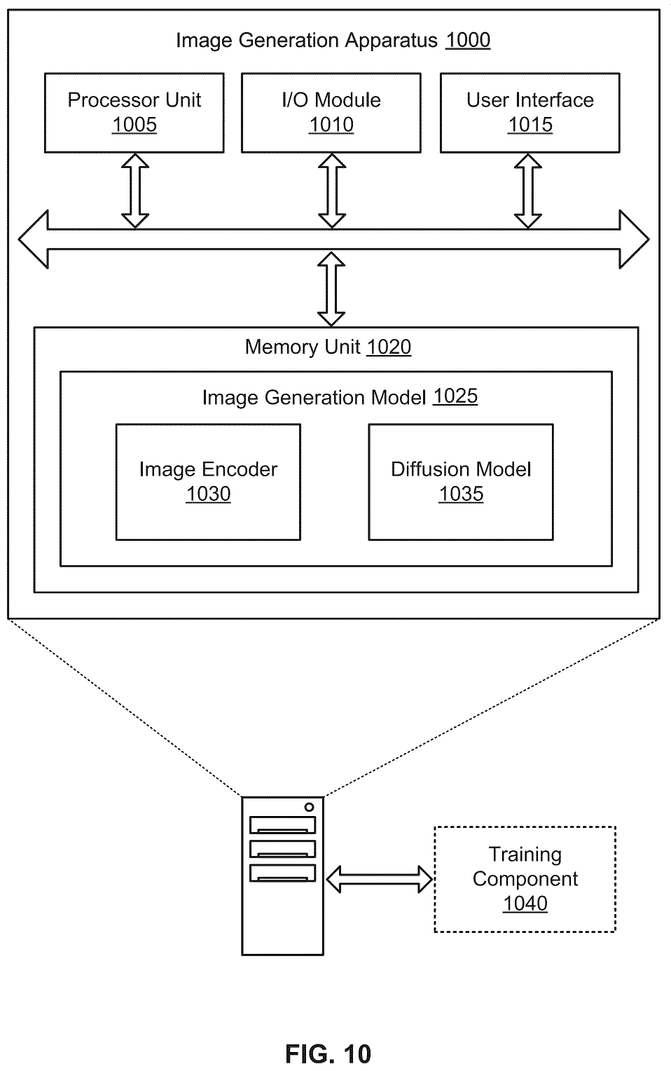

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 10.

In an example shown in FIG. 1, a foreground image and a background image are provided by user 100. For example, the foreground image depicts a toy object and the background image depicts a scene. The scene in the background image includes a dog standing on the ground. User 100 may want to obtain, using image generation apparatus 110, a composite image that includes the toy object from the foreground image. The background image includes a masked region indicating a location and a scale for the toy object. In some cases, the masked region is represented by a bounding box. The foreground image and the background image (including the masked region) are transmitted to image generation apparatus 110, e.g., via user device 105 and cloud 115.

Image generation apparatus 110 encodes, using an image encoder of an image generation model, the foreground image to obtain a foreground embedding, where the foreground embedding preserves an identity of the object. Image generation apparatus 110 generates, using the image generation model, a composite image based on the background image and the foreground embedding. In this example, the composite image depicts the toy object from the foreground image within the scene from the background image. The toy object is located at the location indicated by the masked region. The scale of the toy object is consistent with the scale indicated by the masked region. Image generation apparatus 110 returns the composite image to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer-implemented network comprising an image encoder and a diffusion model. Image generation apparatus 110 may also include a processor unit, a memory unit, an I/O module, and a user interface. A training component may be implemented on an apparatus other than image generation apparatus 110. The training component is used to train an image generation model. Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 10-18. Further detail regarding the operation of image generation apparatus 110 is provided with reference to FIGS. 2, 9 and 19.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., training dataset including training image pairs) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

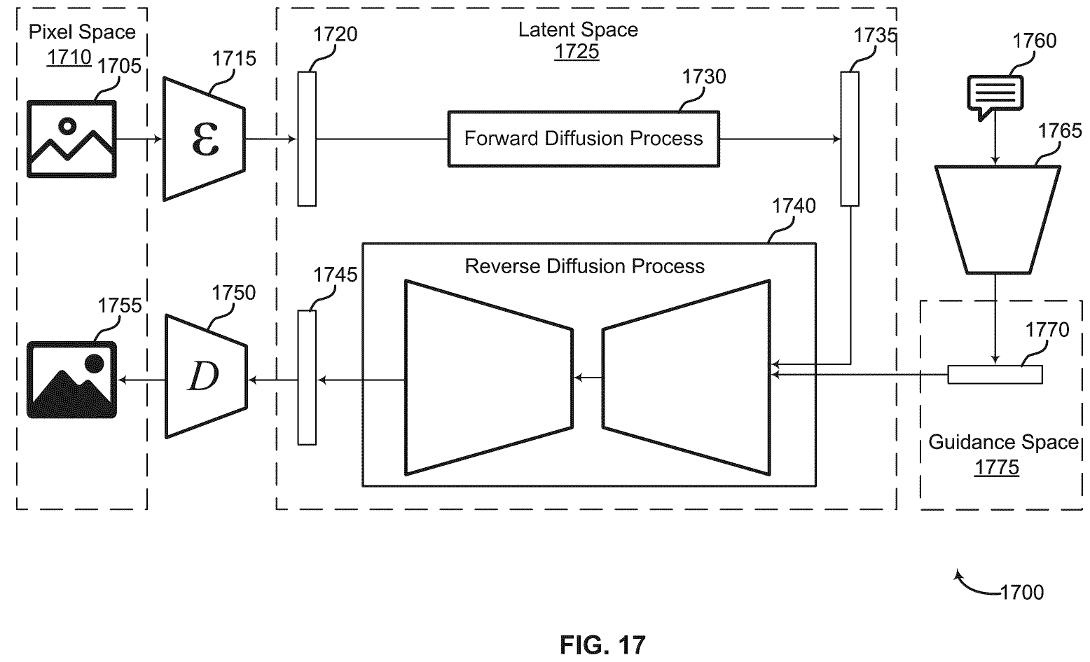

FIG. 2 shows an example of a method 200 for conditional media generation according to aspects of the present disclosure. In some examples, method 200 describes an operation of the image generation model 1025 described with reference to FIG. 10 such as an application of the guided latent diffusion model 1700 described with reference to FIG. 17. In some examples, these operations are performed by a system including a processor executing a set of codes to control functional elements of an apparatus such as the image generation apparatus described in FIGS. 1 and 10.

Additionally or alternatively, steps of the method 200 may be performed using special-purpose hardware. Generally, these operations are performed according to the methods and processes described in accordance with aspects of the present disclosure. In some cases, the operations described herein are composed of various substeps, or are performed in conjunction with other operations.

At operation 205, a user provides a foreground image and a background image. In some cases, the operations of this step refer to, or may be performed by, a user as described with reference to FIG. 1. In some examples, a user provides a foreground image describing content to be included in a generated media item (e.g., a target object in a composite image). For example, the user may provide a foreground image depicting an object and a background image depicting a scene comprising a dog standing on the ground. In some examples, guidance can be provided in a form such as text, an image, a sketch, or a layout.

At operation 210, the system encodes the foreground image. In some cases, the operations of this step refer to, or may be performed by, an image generation apparatus as described with reference to FIGS. 1 and 10.

The image generation apparatus converts the foreground image (or other guidance) into a conditional guidance vector or other multi-dimensional representation. In some cases, the multi-dimensional representation may be referred to as an identity-preserving embedding. For example, the foreground image may be converted into a vector or a series of vectors using a transformer model, or a multi-modal encoder. In some cases, the encoder for the conditional guidance vector is trained independently of the diffusion model.

At operation 215, the system generates a composite image. In some cases, the operations of this step refer to, or may be performed by, an image generation apparatus as described with reference to FIGS. 1 and 10.

In some cases, a noise map is initialized that includes random noise. The noise map may be in a pixel space or a latent space. By initializing a media item with random noise, different variations of a media item including the content described by the conditional guidance can be generated.

The image generation apparatus generates a media item (e.g., a composite image) based on the noise map and the conditional guidance vector. For example, the media item may be generated using a reverse diffusion process as described with reference to FIGS. 17 and 19.

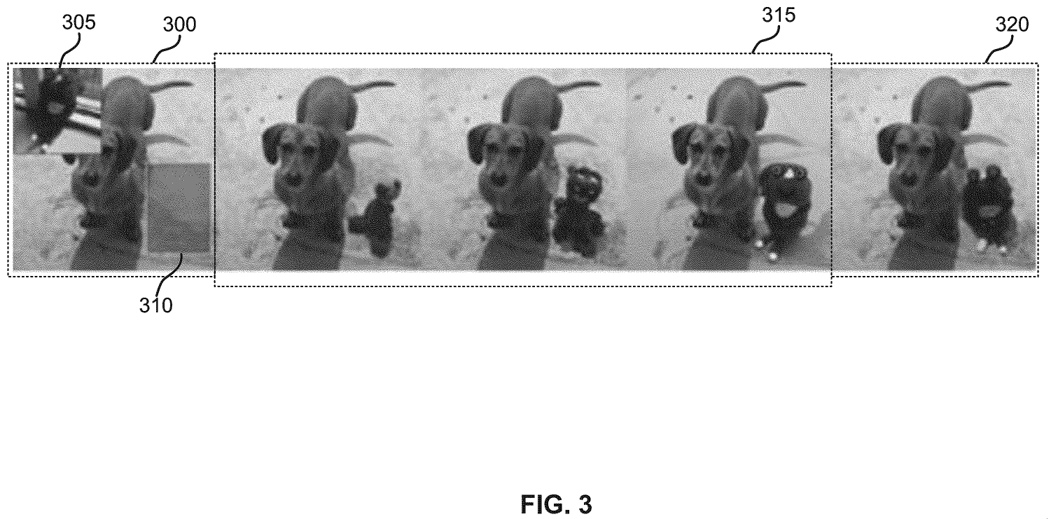

FIG. 3 shows an example of generated composite image 320 according to aspects of the present disclosure. The example shown includes background image 300, foreground image 305, masked region 310, output images 315, and composite image 320.

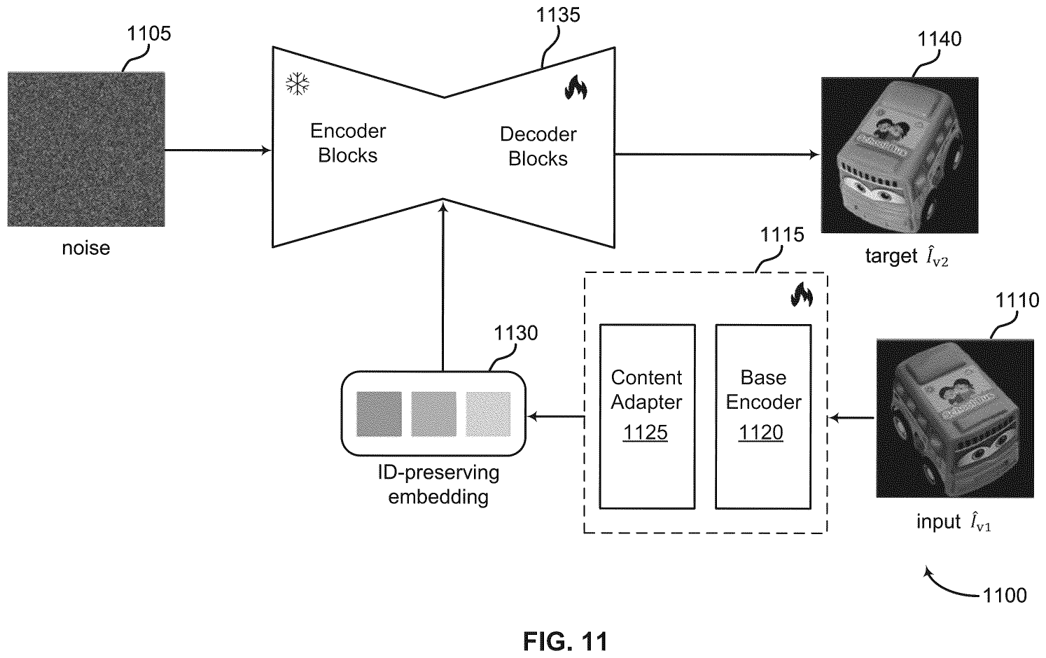

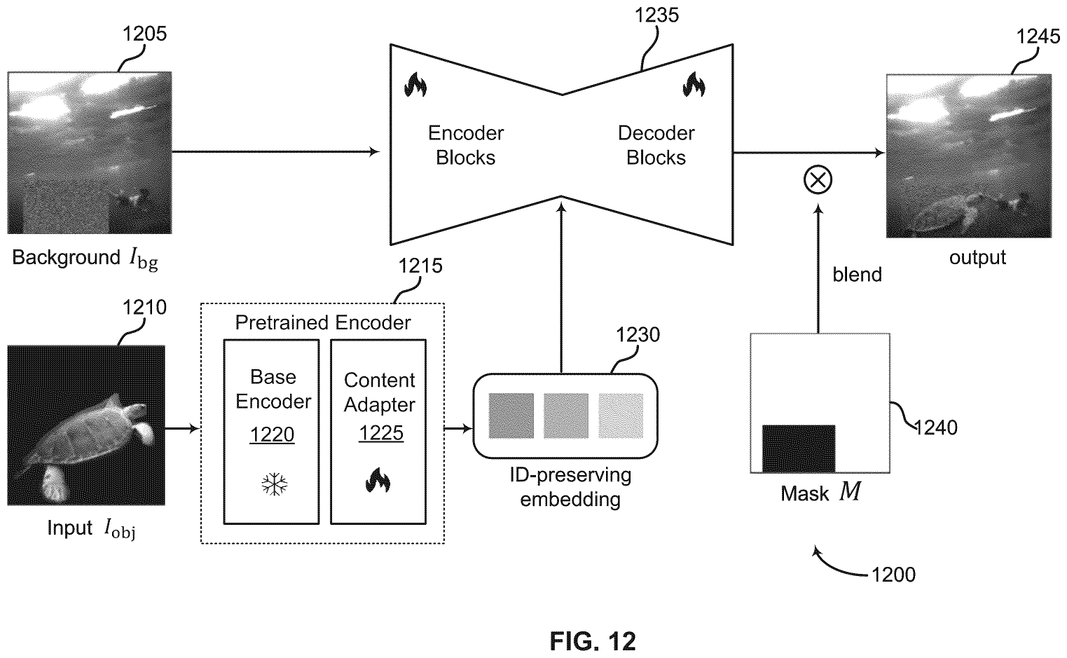

Output images 315 are generated using different conventional image compositing models and are to be compared against composite image 320, which is generated by an image generation model 1025 with reference to FIG. 10. The image generation model 1025 is trained using a two-stage training framework comprising a first training stage (a context-agnostic identity-preserving stage) and a second training stage (an object compositing stage) as described in FIGS. 11 and 12, respectively.

The composite image 320 is generated based on foreground image 305 and background image 300 including masked region 310. Background image 300 provides scene-related context for generating the composite image 320. Foreground image 305 provides an element or an object to be placed within background image 300. Masked region 310 provides information regarding the desired position, size and scale of a target object (e.g., a toy object) as the image generation model 1025 performs generative image composition based on background image 300 and foreground image 305. In some examples, masked region 310 is marked or identified by an input mask (e.g., a bounding box). The bounding box indicates size and scale of the target object and the location of the target object in relation to the background. After being merged with background image 300, the object or element of foreground image 305 is expected to be altered in terms of color, lighting, and geometry to align with background image 300, while still maintaining visual consistency with foreground image 305.

In comparison to output images 315, composite image 320 has increased image quality in terms of visual consistency of the foreground image 305, identity preservation, and detail retention.

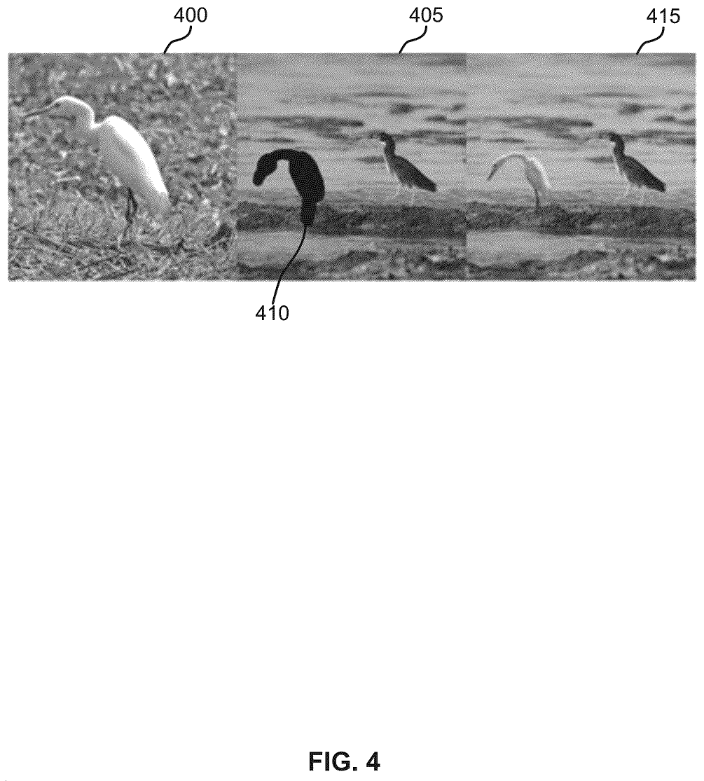

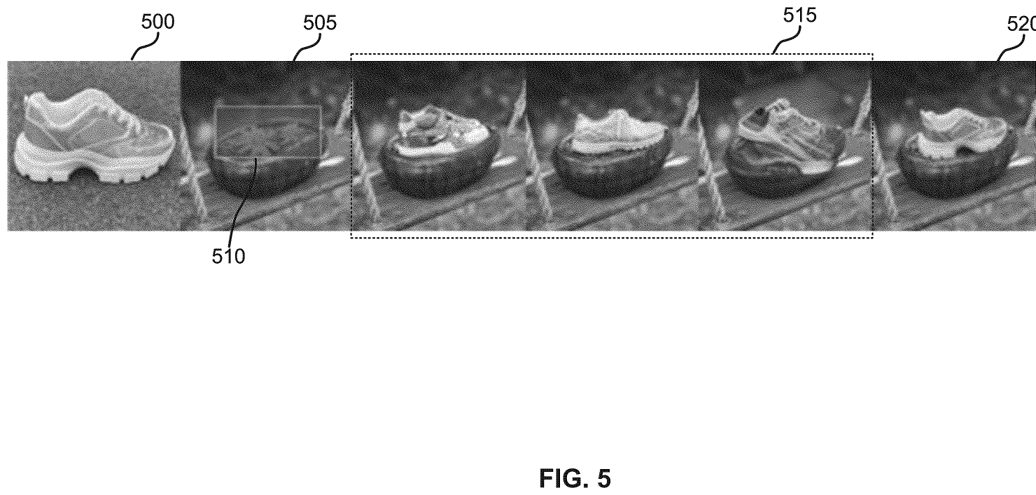

Background image 300 is an example of, or includes aspects of, the corresponding element described with reference to FIGS. 4-8, 13-15, and 27. Foreground image 305 is an example of, or includes aspects of, the corresponding element described with reference to FIGS. 4-8, 14-16, 26, and 27. Masked region 310 is an example of, or includes aspects of, the corresponding element described with reference to FIGS. 5, 7, 8, and 27. Output images 315 is an example of, or includes aspects of, the corresponding element described with reference to FIGS. 5, 7, and 8. Composite image 320 is an example of, or includes aspects of, the corresponding element described with reference to FIGS. 4-8, 14, and 15.

FIG. 4 shows an example of generated composite image 415 according to aspects of the present disclosure. The example shown includes foreground image 400, background image 405, input mask 410, and composite image 415.

Composite image 415 is generated using an image generation model trained via a two-stage training framework. The two-stage training framework includes a first training stage (a context-agnostic identity-preserving stage), and a second training stage (an object compositing stage) as described in FIGS. 11 and 12, respectively. In some embodiments, an image composite model takes foreground image 400, background image 405, and input mask 410 as inputs and generates composite image 415 based on the inputs.

Background image 405 depicts a scene and provides context for generating composite image 415. Foreground image 400 provides an element or an object to be merged with background image 405. Input mask 410 provides information regarding the desired position, size and scale of the element/object from foreground image 400 when merged with background image 405. Additionally, input mask 410 provides information regarding the desired pose, orientation, location, size and scale of the element or object from the foreground image 400 as the same element/object is generated in composite image 415. In some examples, input mask 410 includes tighter boundary around a target object (e.g., resembling the shape of the target object) compared to a bounding box. Input mask 410 indicates a location of the object in relation to the background.

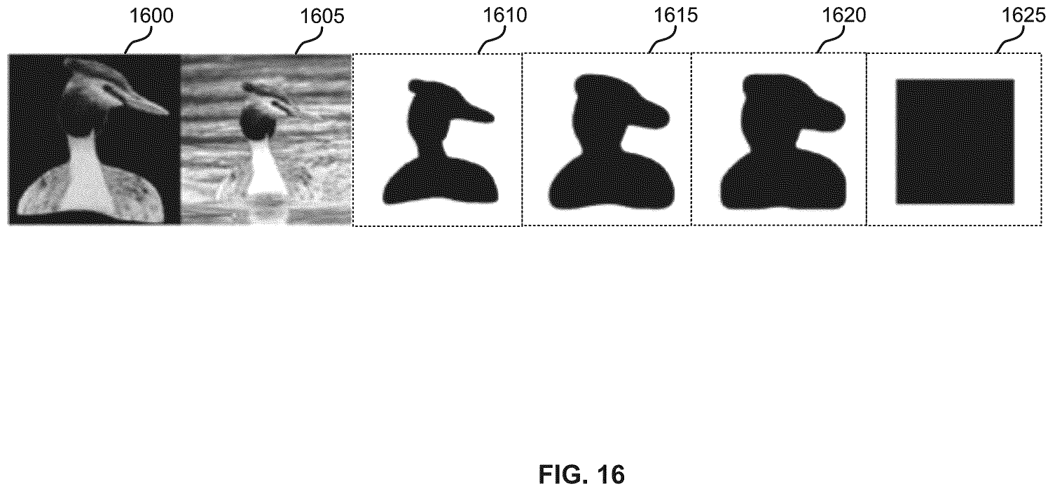

In some cases, the shape of input mask 410 may not match the exact shape of the object in foreground image 400 while input mask 410 is meant to depict the same object/element (i.e., a bird). Some embodiments of the present disclosure generate composite image 415 including the object from foreground image 400 to follow the shape and scale of input mask 410 as the same object (e.g., the bird) is generated based on background image 405 and input mask 410. The resulting composite image 415 includes the object of foreground image 400, posed and shaped according to input mask 410. Input mask 410 can have varying levels of coarseness, as described in greater detail in FIG. 16.

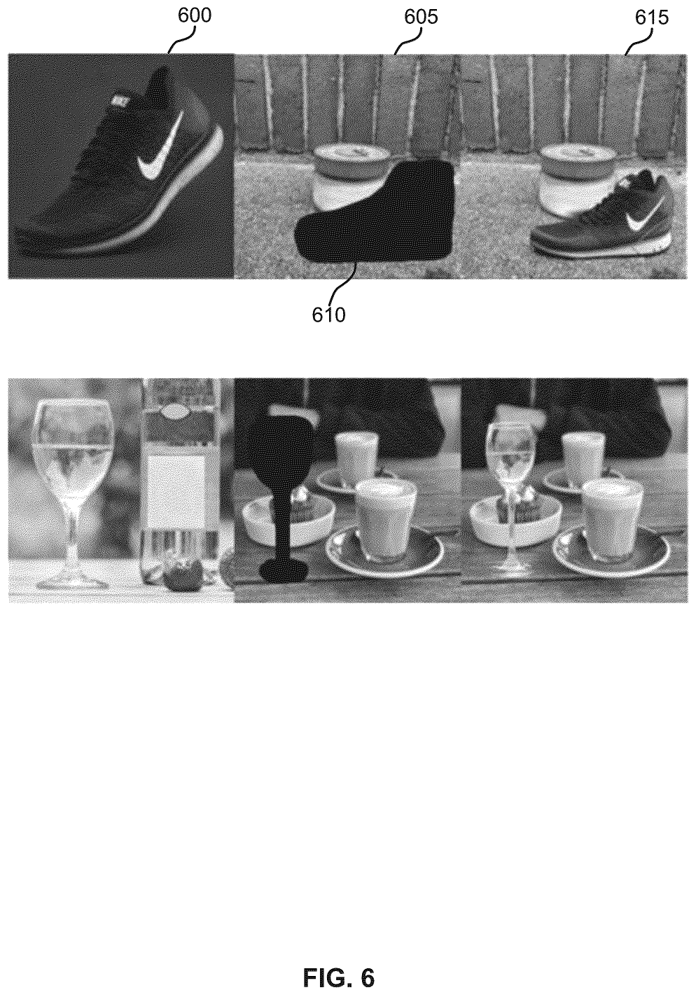

Foreground image 400 is an example of, or includes aspects of, the corresponding element described with reference to FIGS. 3, 5-8, 14-16, 26, and 27. Background image 405 is an example of, or includes aspects of, the corresponding element described with reference to FIGS. 3, 5-8, 13-15, and 27. Input mask 410 is an example of, or includes aspects of, the corresponding element described with reference to FIGS. 6, and 12-15. Composite image 415 is an example of, or includes aspects of, the corresponding element described with reference to FIGS. 3, 5-8, 14, and 15.

FIG. 5 shows an example of generated composite image 520 according to aspects of the present disclosure. The example shown includes foreground image 500, background image 505, masked region 510, output images 515, and composite image 520.

Output images 515 are generated using different conventional image compositing models and are to be compared against composite image 520, which is generated using an image generation model trained via two-stage training framework. The two-stage training framework includes a first training stage (a context-agnostic identity-preserving stage), and a second training stage (an object compositing stage) as described in FIGS. 11 and 12, respectively.

An image generation model with reference to FIG. 10 generates composite image 520 based on foreground image 500 and background image 505. The background image 505 includes a masked region 510 indicating a location and a scale for the object in the foreground image 500 (e.g., a shoe). Background image 505 depicts a scene and provides context for generating composite image 520. Foreground image 500 provides an element or an object to be merged with background image 505. Masked region 510 provides information regarding the desired position, orientation, size and scale of foreground image 500 as the image generation model generates composite image 520 based on foreground image 500 and background image 505.

In comparison to output images 515, composite image 520 has increased image quality in terms of visual consistency of the foreground image 500, while still making geometric changes to the object from foreground image 500. The composite image 520 includes the same object (e.g., the shoe) being stylistically coherent with the scene in background image 505 and masked region 510. By contrast, output images 515 show decreased object detail, and conventional models simply duplicate the pose of the object from foreground image 500 without making context-appropriate changes to the object's orientation and/or pose.

Foreground image 500 is an example of, or includes aspects of, the corresponding element described with reference to FIGS. 3, 4, 6-8, 14-16, 26, and 27. Background image 505 is an example of, or includes aspects of, the corresponding element described with reference to FIGS. 3, 4, 6-8, 13-15, and 27. Masked region 510 is an example of, or includes aspects of, the corresponding element described with reference to FIGS. 3, 7, 8, and 27. Output images 515 is an example of, or includes aspects of, the corresponding element described with reference to FIGS. 3, 7, and 8. Composite image 520 is an example of, or includes aspects of, the corresponding element described with reference to FIGS. 3, 4, 6-8, 14, and 15.

FIG. 6 shows an example of shape-guided generation and shape control effect according to aspects of the present disclosure. The example shown includes foreground image 600, background image 605, input mask 610, and composite image 615.

Composite image 615 is generated based on an element or object from foreground image 600 and scene depicted in background image 605. The background image 605 includes input mask 610 which indicates size, scale, position, orientation, pose and shape information. In some cases, the shape of input mask 610 may not match the shape of the element or object in foreground image 600. Input mask 610 guides an image generation model to adjust the shape or orientation of the object from foreground image 600 to align with the shape, size and orientation of input mask 610.

The image generation model may change the view or pose of the object from foreground image 600 or apply non-rigid transformations according to the shape and orientation of input mask 610. In some examples, the object of foreground image 600 is positioned at an angle in composite image 615 which is different from the angle in foreground image 600. In some examples, the object of foreground image 600 may be elongated along a dimension in composite image 615.

Shape-guided generation provides more flexibility for image editing, as a user has control over the shape, view and pose of objects, and the transformation can be either rigid or non-rigid. Input mask 610 is used as guidance for image editing. In some examples, input mask 610 includes four types of masks (e.g., a bounding box). In addition to object compositing, image generation model 1025 (described with reference to FIG. 10) also performs edits on the input object. Depending on the shape of the coarse mask, image generation model 1025 can operate different types of editing, such as changing the view of an object, applying non-rigid transformation on the object, etc.

Foreground image 600 is an example of, or includes aspects of, the corresponding element described with reference to FIGS. 3-5, 7, 8, 14-16, 26, and 27. Background image 605 is an example of, or includes aspects of, the corresponding element described with reference to FIGS. 3-5, 7, 8, 13-15, and 27. Input mask 610 is an example of, or includes aspects of, the corresponding element described with reference to FIGS. 4, and 12-15. Composite image 615 is an example of, or includes aspects of, the corresponding element described with reference to FIGS. 3-5, 7, 8, 14, and 15.

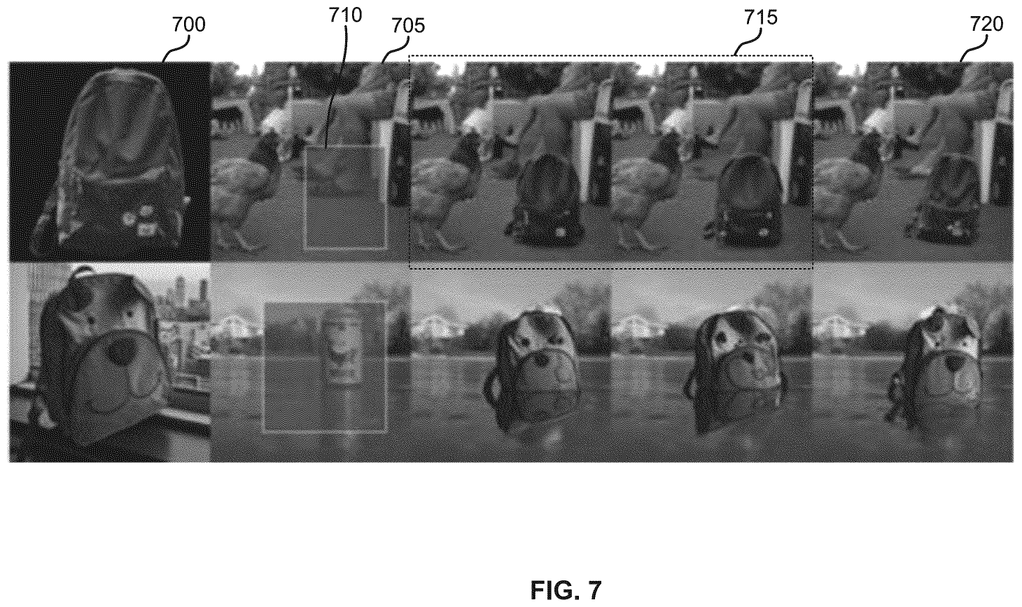

FIG. 7 shows an example of generated composite image 720 according to aspects of the present disclosure. The example shown includes foreground image 700, background image 705, masked region 710, output images 715, and composite image 720.

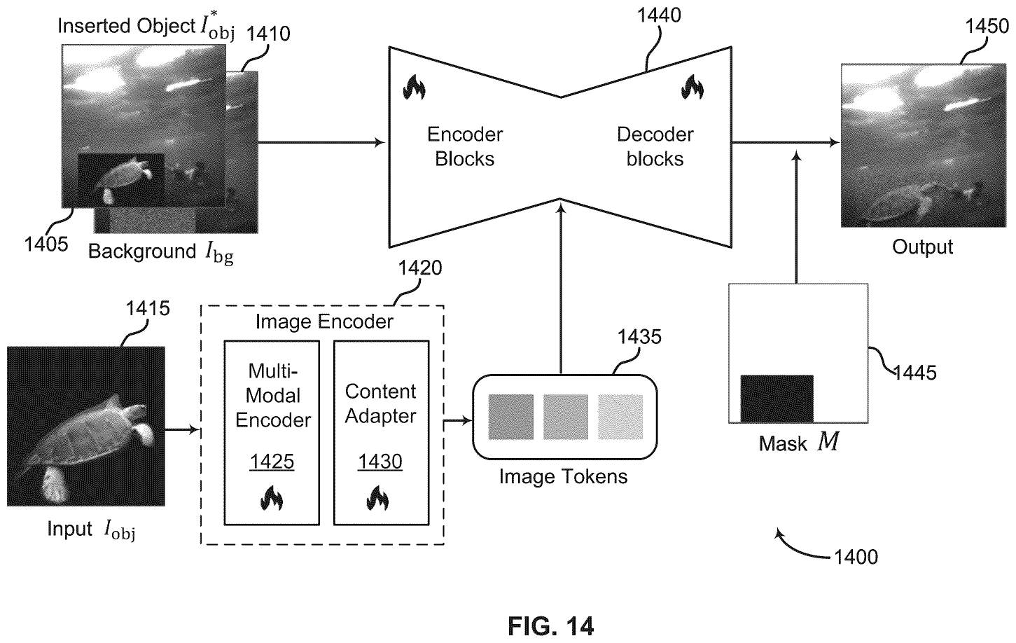

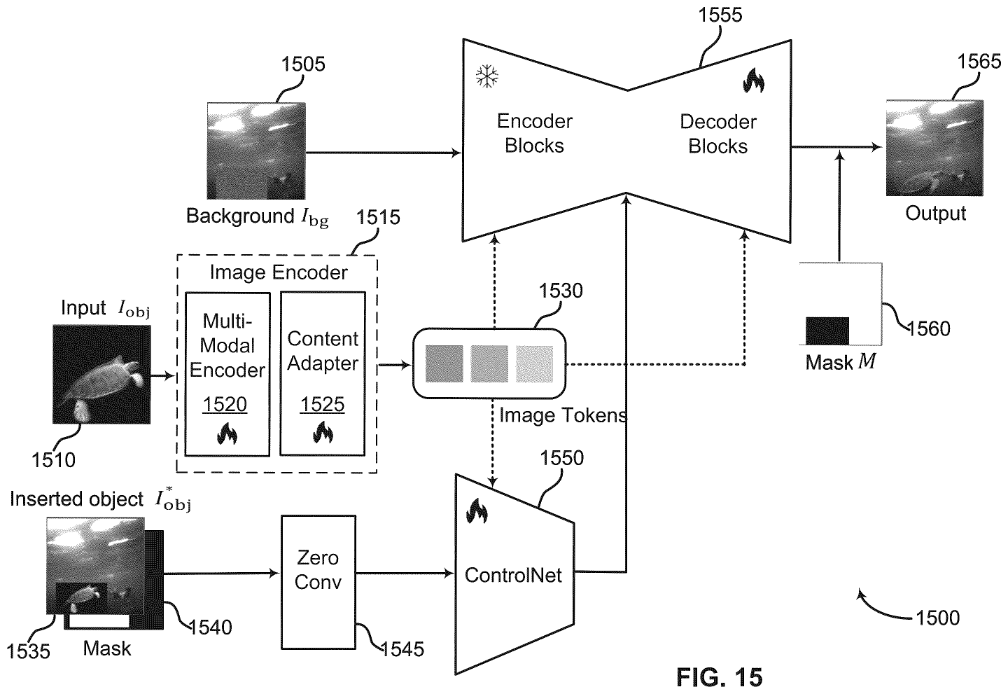

Image generation model 1025 with reference to FIG. 10 takes foreground image 700 and background image 705 (comprising masked region 710) as input and generates composite image 720. The image generation model applies either a concatenation architecture (as shown in FIG. 14) or a ControlNet architecture (as shown in FIG. 15). Output images 715 show images produced by a concatenation architecture and a ControlNet architecture, respectively.

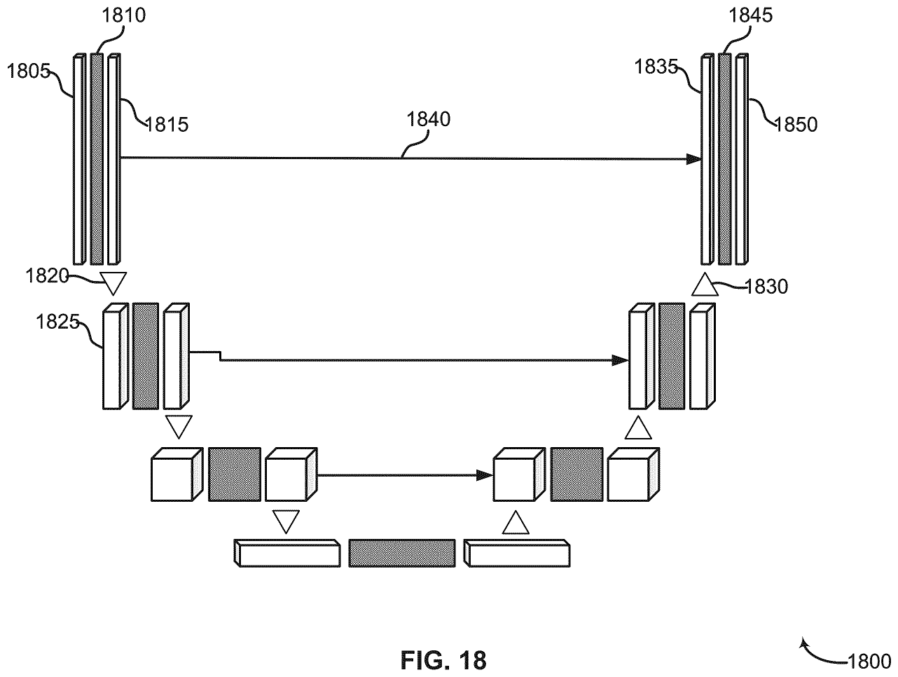

Output images 715 which are produced via a concatenation architecture are generated by concatenating a modified version of foreground image 700 with background image 705, where the modified version of foreground image 700 is a cropped and resized object from foreground image 700, fitted in the mask area of background image 705. The concatenated image is then sent to a U-Net encoder as described in FIG. 18, and a composite image is generated (output images 715). In some embodiments, the U-Net encoder has 8 input channels, 4 of the channels being initialized as 0.0.

Output images 715 which are produced via a ControlNet architecture are generated by inputting a foreground image 700, a background image 705, and a concatenated object of a similarly modified version of foreground image 700 and a masked region 710. These inputs are fed to a U-Net encoder, as described in FIG. 18, and a composite image is generated (output images 715).

Composite image 720 is generated using an image generation model that takes foreground image 700 and background image 705 (comprising masked region 710) as inputs. The foreground image 700 includes a target object (e.g., the bag). Composite image 720 is to be compared to output images 715 generated by alternative models as described in FIGS. 14 and 15. In comparison to output images 715, composite image 720 has increased image quality in terms of visual consistency of foreground image 700, identity preservation, and geometric adjustments to match the scene and context depicted in background image 705.

Foreground image 700 is an example of, or includes aspects of, the corresponding element described with reference to FIGS. 3-6, 8, 14-16, 26, and 27. Background image 705 is an example of, or includes aspects of, the corresponding element described with reference to FIGS. 3-6, 8, 13-15, and 27. Masked region 710 is an example of, or includes aspects of, the corresponding element described with reference to FIGS. 3, 5, 8, and 27. Output images 715 is an example of, or includes aspects of, the corresponding element described with reference to FIGS. 3, 5, and 8. Composite image 720 is an example of, or includes aspects of, the corresponding element described with reference to FIGS. 3-6, 8, 14, and 15.

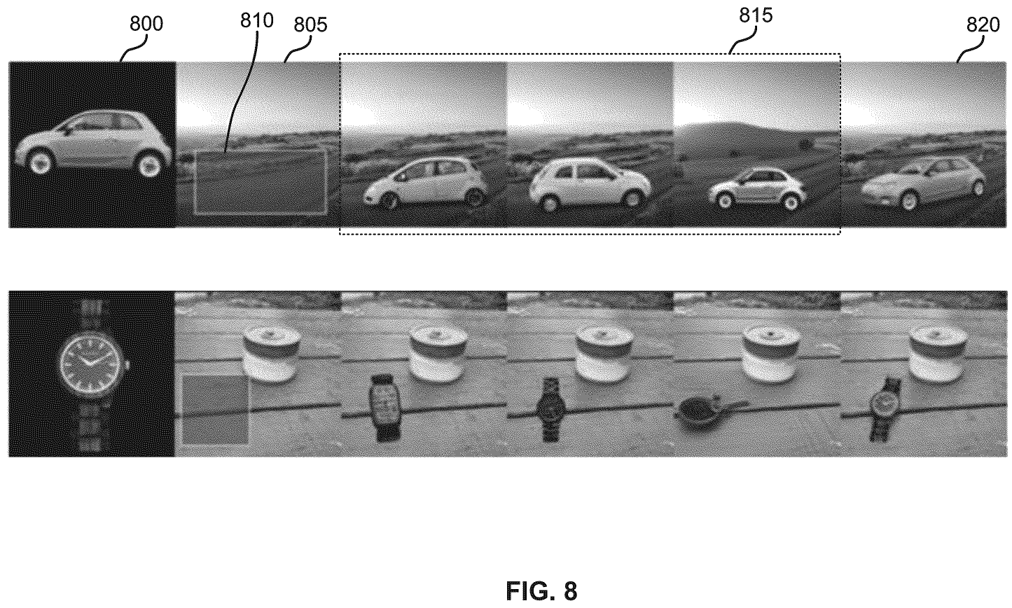

FIG. 8 shows an example of generated composite image 820 according to aspects of the present disclosure. The example shown includes foreground image 800, background image 805, masked region 810, output images 815, and composite image 820.

Output images 815 are generated using different conventional image compositing models and are to be compared against composite image 820, which is generated using an image generation model trained via a two-stage training framework. The two-stage training framework includes a first training stage (a context-agnostic identity-preserving stage), and a second training stage (an object compositing stage) as described in FIGS. 11 and 12, respectively.

An image generation model 1025 with reference to FIG. 10 generates composite image 820 based on foreground image 800 and background image 805. The background image 805 includes masked region 810. Background image 805 depicts a scene and provides context for generating composite image 820. Foreground image 800 includes an element or an object to be merged within the scene of background image 805. Masked region 810 provides information regarding the desired position, orientation, pose, size and scale of the object from foreground image 800 (e.g., a car) as the image generation model generates composite image 820.

In comparison to output images 815, composite image 820 has increased image quality in terms of visual consistency of the foreground image 800, identity preservation, and consistency with background image 805.

Foreground image 800 is an example of, or includes aspects of, the corresponding element described with reference to FIGS. 3-7, 14-16, 26, and 27. Background image 805 is an example of, or includes aspects of, the corresponding element described with reference to FIGS. 3-7, 13-15, and 27. Masked region 810 is an example of, or includes aspects of, the corresponding element described with reference to FIGS. 3, 5, 7, and 27. Output images 815 is an example of, or includes aspects of, the corresponding element described with reference to FIGS. 3, 5, and 7. Composite image 820 is an example of, or includes aspects of, the corresponding element described with reference to FIGS. 3-7, 14, and 15.

FIG. 9 shows an example of a method 900 for image processing and object composition according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains a foreground image and a background image, where the foreground image depicts an object and the background image depicts a scene. In some cases, the operations of this step refer to, or may be performed by, an image generation model as described with reference to FIGS. 10, 14, and 15. In some examples, a foreground image includes a target object. Referring to an example in FIG. 3, foreground image 305 includes an “toy” object. Background image 300 depicts a scene. In an embodiment, the system merges the target object with a background to obtain a composite image. In some cases, the system obtains an input mask indicating a location of the object in the scene. Additionally or alternatively, the background image includes a masked region indicating a location and a scale for the object.

At operation 910, the system encodes, using an image encoder of an image generation model, the foreground image to obtain a foreground embedding, where the foreground embedding preserves an identity of the object. In some cases, the operations of this step refer to, or may be performed by, an image encoder as described with reference to FIGS. 10-12, 14, and 15. In an embodiment, the image encoder includes a base encoder (e.g., DINO encoder) and a content adapter. The image encoder is trained to preserve an object identity during a first training stage. For example, the image encoder (both the base encoder and the content adapter) and decoder blocks of a diffusion model are trained and optimized during the first training stage.

In an embodiment, the image encoder and a decoder of an image generation model are trained to combine images during a second training stage. The content adapter of the image encoder learned from the first training stage and the entire diffusion model (both encoder blocks and decoder blocks of the diffusion model) are jointly trained during the second training stage.

At operation 915, the system generates, using the image generation model, a composite image based on the background image and the foreground embedding, where the composite image depicts the object from the foreground image within the scene from the background image. In some cases, the operations of this step refer to, or may be performed by, an image generation model as described with reference to FIGS. 10, 14, and 15.

In some examples, given a coarse mask, an image generation model changes the pose of the object to follow the shape of the coarse mask. Referring to an example in FIG. 4, input mask 410 indicates a location and a scale for the “bird” object, which is different from a location and a scale for the “bird” object in foreground image 400. Composite image 415 includes a “bird” object that follows the shape, pose, and orientation of the coarse mask.

In FIGS. 1-9, a method, apparatus, and non-transitory computer readable medium for image processing are described. One or more embodiments of the method, apparatus, and non-transitory computer readable medium include obtaining a foreground image and a background image, wherein the foreground image depicts an object and the background image depicts a scene; encoding, using an image encoder of an image generation model, the foreground image to obtain a foreground embedding, wherein the foreground embedding preserves an identity of the object; and generating, using the image generation model, a composite image based on the background image and the foreground embedding, wherein the composite image depicts the object from the foreground image within the scene from the background image.

Some examples of the method, apparatus, and non-transitory computer readable medium further include obtaining a preliminary image. Some examples further include removing a background from the preliminary image to obtain the foreground image.

In some examples, the background image comprises a masked region indicating a location and a scale for the object. Some examples of the method, apparatus, and non-transitory computer readable medium further include obtaining an input mask indicating a location of the object in the scene, wherein the composite image is generated based on the input mask.

Some examples of the method, apparatus, and non-transitory computer readable medium further include obtaining a noise map. Some examples further include denoising the noise map based on the foreground embedding. In some examples, the noise map is generated based on the background image.

In some examples, the image encoder is trained to preserve an object identity during a first training stage and wherein the image encoder and a decoder of the image generation model are trained to combine images during a second training stage.

### Network Architecture

FIG. 10 shows an example of an image generation apparatus 1000 according to aspects of the present disclosure. The example shown includes image generation apparatus 1000, processor unit 1005, I/O module 1010, user interface 1015, memory unit 1020, image generation model 1025, and training component 1040. Image generation apparatus 1000 is an example of, or includes aspects of, the corresponding element described with reference to FIG. 1.

Image generation apparatus 1000 may include an example of, or aspects of, the guided diffusion model described with reference to FIG. 17 and the U-Net described with reference to FIG. 18. In some embodiments, image generation apparatus 1000 includes processor unit 1005, I/O module 1010, user interface 1015, memory unit 1020, image generation model 1025, and training component 1040. Training component 1040 updates parameters of the image generation apparatus 1000 stored in memory unit 1020. In some examples, the training component 1040 is located outside the image generation apparatus 1000.

Processor unit 1005 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

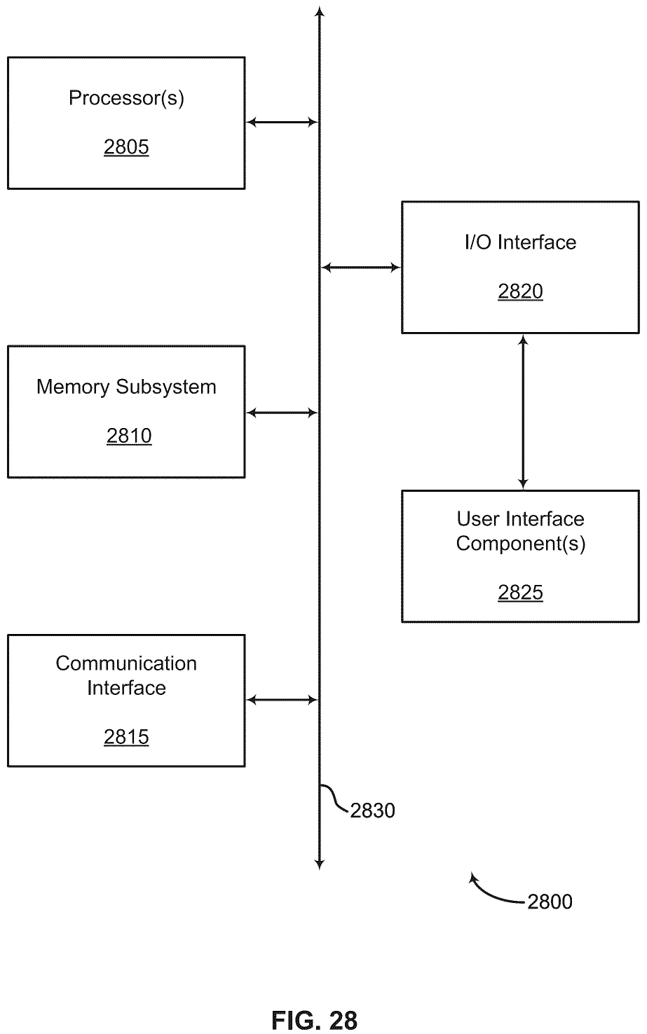

In some cases, processor unit 1005 is configured to operate a memory array using a memory controller. In other cases, a memory controller is integrated into processor unit 1005. In some cases, processor unit 1005 is configured to execute computer-readable instructions stored in memory unit 1020 to perform various functions. In some aspects, processor unit 1005 includes special purpose components for modem processing, baseband processing, digital signal processing, or transmission processing. According to some aspects, processor unit 1005 comprises one or more processors described with reference to FIG. 28.

Memory unit 1020 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1005 to perform various functions described herein.

In some cases, memory unit 1020 includes a basic input/output system (BIOS) that controls basic hardware or software operations, such as an interaction with peripheral components or devices. In some cases, memory unit 1020 includes a memory controller that operates memory cells of memory unit 1020. For example, the memory controller may include a row decoder, column decoder, or both. In some cases, memory cells within memory unit 1020 store information in the form of a logical state. According to some aspects, memory unit 1020 is an example of the memory subsystem 2810 described with reference to FIG. 28.

According to some aspects, image generation apparatus 1000 uses one or more processors of processor unit 1005 to execute instructions stored in memory unit 1020 to perform functions described herein. For example, image generation apparatus 1000 may obtain a foreground image and a background image, where the foreground image depicts an object and the background image depicts a scene; encode, using an image encoder of an image generation model, the foreground image to obtain a foreground embedding, where the foreground embedding preserves an identity of the object; and generate, using the image generation model, a composite image based on the background image and the foreground embedding, where the composite image depicts the object from the foreground image within the scene from the background image.

The memory unit 1020 may include an image generation model 1025 trained to obtain a foreground image and a background image, wherein the foreground image depicts an object and the background image depicts a scene; encode, using an image encoder of an image generation model, the foreground image to obtain a foreground embedding, wherein the foreground embedding preserves an identity of the object; and generate, using the image generation model, a composite image based on the background image and the foreground embedding, wherein the composite image depicts the object from the foreground image within the scene from the background image. For example, after training, the image generation model 1025 may perform inferencing operations as described with reference to FIGS. 2 and 9.

In some embodiments, the image generation model 1025 is an Artificial neural network (ANN) such as the guided diffusion model described with reference to FIG. 17 and the U-Net described with reference to FIG. 18. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1025 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

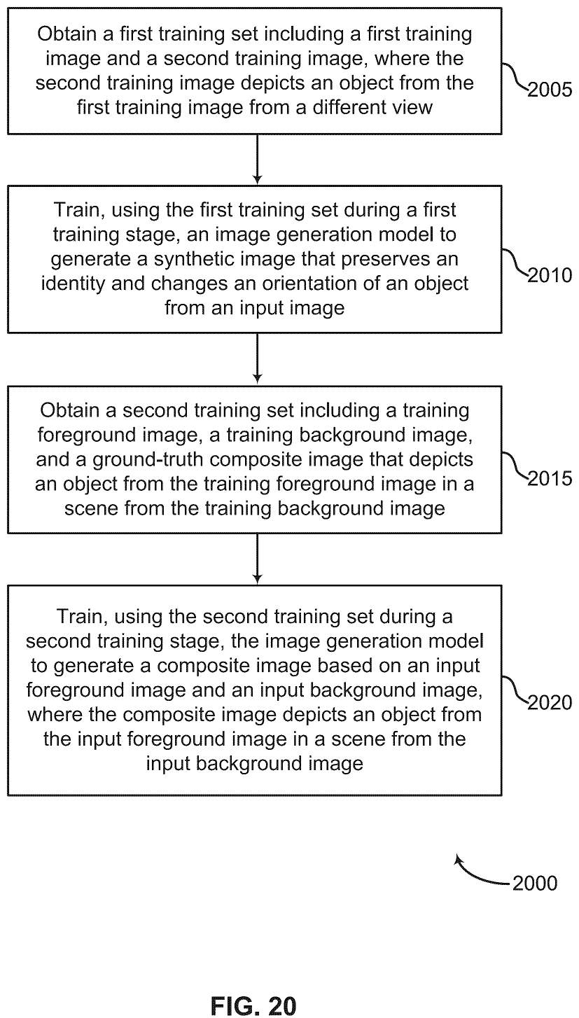

Training component 1040 may train the image generation model 1025. For example, parameters of the image generation model 1025 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 20-24). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1025 can be used to make predictions on new, unseen data (i.e., during inference).

I/O module 1010 receives inputs from and transmits outputs of the image generation apparatus 1000 to other devices or users. For example, I/O module 1010 receives inputs for the image generation model 1025 and transmits outputs of the image generation model 1025. According to some aspects, I/O module 1010 is an example of the I/O interface 2820 described with reference to FIG. 28.

According to some embodiments, image generation model 1025 obtains a foreground image and a background image, where the foreground image depicts an object and the background image depicts a scene. In some examples, image generation model 1025 generates a composite image based on the background image and the foreground embedding, where the composite image depicts the object from the foreground image within the scene from the background image.

In some examples, image generation model 1025 obtains a preliminary image. Image generation model 1025 removes a background from the preliminary image to obtain the foreground image. In some examples, the background image includes a masked region indicating a location and a scale for the object. In some examples, image generation model 1025 obtains an input mask indicating a location of the object in the scene, where the composite image is generated based on the input mask.

According to some embodiments, image generation model 1025 comprises parameters stored in the at least one memory and is trained to encode a foreground image to obtain a foreground embedding that preserves an identity of an object in the foreground image and generates a composite image based on a background image and the foreground embedding, wherein the composite image depicts the object from the foreground image within a scene from the background image. In some examples, the image generation model 1025 includes an image encoder 1030 that encodes the foreground image and an image generator that generates the composite image. In some examples, the image generation model 1025 includes a diffusion U-Net according to aspects of the corresponding element described with reference to FIG. 18.

In one aspect, image generation model 1025 includes image encoder 1030 and diffusion model 1035. Image generation model 1025 is an example of, or includes aspects of, the corresponding element described with reference to FIGS. 14 and 15.

According to some embodiments, image encoder 1030 encodes the foreground image to obtain a foreground embedding, where the foreground embedding preserves an identity of the object. In some examples, the image encoder 1030 is trained to preserve an object identity during a first training stage and where the image encoder 1030 and a decoder of the image generation model 1025 are trained to combine images during a second training stage. In some examples, the image encoder 1030 includes a base encoder and a content adapter. Image encoder 1030 is an example of, or includes aspects of, the corresponding element described with reference to FIGS. 11, 12, 14, and 15.

According to some embodiments, diffusion model 1035 obtains a noise map. In some examples, diffusion model 1035 denoises the noise map based on the foreground embedding. In some examples, the noise map is generated based on the background image. Diffusion model 1035 is an example of, or includes aspects of, the corresponding element described with reference to FIGS. 11-15.

According to some embodiments, training component 1040 obtains a first training set including a first training image and a second training image, where the second training image depicts an object from the first training image from (i.e., in) a different view. In some examples, training component 1040 trains, using the first training set during a first training stage, an image generation model 1025 to generate a synthetic image that preserves an identity while changing an orientation, pose, or scale of an object from an input image. Training component 1040 obtains a second training set including a training foreground image, a training background image, and a ground-truth composite image that depicts an object from the training foreground image in a scene from the training background image. Training component 1040 trains, using the second training set during a second training stage, the image generation model 1025 to generate a composite image based on an input foreground image and an input background image, where the composite image depicts an object from the input foreground image in a scene from the input background image.

In some examples, training component 1040 generates a preliminary output based on the first training image. Training component 1040 computes an identity preserving loss based on the preliminary output and the second training image. Training component 1040 updates parameters of the image generation model 1025 based on the identity preserving loss.

In some examples, training component 1040 initializes the image generation model 1025 using parameters of a pre-trained base model. Training component 1040 freezes an encoder layer of the image generation model 1025 during the first training stage. In some examples, training component 1040 trains the encoder layer of the image generation model 1025 during the second training stage.

In some examples, training component 1040 generates a preliminary composite output based on the training foreground image and the training background image. Training component 1040 computes a compositing loss based on the preliminary composite output and the ground-truth composite image. Training component 1040 updates parameters of the image generation model 1025 based on the compositing loss.

In some examples, training component 1040 freezes an image encoder 1030 of the image generation model 1025 during the second training stage. In some examples, training component 1040 trains the image encoder 1030 of the image generation model 1025 during the first training stage.

FIG. 11 shows an example of an image generation model according to aspects of the present disclosure. The example shown includes first training stage 1100, noise map 1105, first training image 1110, image encoder 1115, foreground embedding 1130, diffusion model 1135, and second training image 1140.

FIGS. 11 and 12 show an example of an object compositing framework. In some cases, given input images of object I_{obj} ∈ [symbol] , background I_{bg}∈ [symbol] , and mask M∈ [symbol] that indicates the location and scale for object compositing to the background, an image generation model 1025 with reference to FIG. 10 is trained to learn a compositing model C such that the compositing model C generates a composite image Iₒᵤₜ=C(I_{obj}, I_{bg}, M)∈ [symbol] . The target outcome is denoted as Iₒᵤₜ that appears visually coherent and natural, i.e., C is trained to ensure that the composited object retains the identity of I_{obj}, aligns to the geometry of I_{bg}, and blends seamlessly into the background.

To leverage pre-trained text-to-image diffusion models, image generation model 1025 includes an image encoder 1115 to replace the text-encoding branch, thus retaining much richer information from the reference object. Image generation model 1025 bifurcates the training task into two sub-tasks to concurrently ensure object fidelity and increase geometric variations.

The First training stage 1100 relates to a stage of context-agnostic identity preserving. The image encoder 1115 (including a pre-trained backbone such as DINOv2) is trained on multi-view object pairs to learn view-invariant identity-preserving representation(s) (i.e., foreground embedding 1130).

In some embodiments, image generation model 1025 is trained using a two-stage training scheme involving the first training stage 1100 described in FIG. 11 and a second training stage 1200 described with reference to FIG. 12.

The first training stage 1100 involves a context-agnostic identity-preserving task, where the image encoder 1115 is trained to learn a unified representation of generic objects. The second training stage 1200 (see FIG. 12) includes training an image generator for image compositing tasks.

In some examples, the first training stage 1100 includes a supervised object view reconstruction task that helps preserve identity. In some examples, the supervised object view reconstruction task is described as follows. Given an object of two views Iᵥ₁, Iᵥ₂ and their associated masks Mᵥ₁, Mᵥ₂, the background is removed and the segmented object pairs are denoted as Îᵥ₁=Iᵥ₁⊗Mᵥ₁, Iᵥ₂⊗Mᵥ₂. The image generation model 1025 includes a view synthesis model S={εᵤ [symbol] _{θ}} conditioned on Îᵥ₁ to generate the target view Îᵥ₂, where εᵤ is used to refer to the image encoder 1115 and [symbol] _{θ} is U-Net backbone parameterized by θ. In some cases, Îᵥ₁ is used to refer to first training image 1110. The target view Îᵥ₂ is used to refer to second training image 1140. The output from [symbol] _{θ} is a synthetic image. The output from εᵤ is foreground embedding 1130.

In one embodiment, image encoder 1115 includes base encoder 1120 and content adapter 1125. Image encoder 1115 is an example of, or includes aspects of, the corresponding element described with reference to FIGS. 10, 12, 14, and 15. Base encoder 1120 is an example of, or includes aspects of, the corresponding element described with reference to FIG. 12. Content adapter 1125 is an example of, or includes aspects of, the corresponding element described with reference to FIGS. 12, 14, and 15.

In some examples, image encoder 1115 (denoted as εᵤ) includes a pre-trained base encoder 1120 (e.g., DINOv2) and content adapter 1125. In some examples, image encoder 1115 (e.g., including DINOv2 or a ViT model) extracts highly expressive visual features for reference-based generation. The content adapter 1125 enables the utilization of pre-trained text-to-image generation models by bridging the domain gap between image embedding space and text embedding space.

Image decoder [symbol] _{θ} takes the conditional denoising autoencoder [symbol] _{θ} from a latent diffusion model (e.g., Stable Diffusion) and fine-tune its decoder during training. The objective function is formulated as follows:

$${ℒ}_{i d} = {𝔼}_{{\hat{I}}_{v 1} , {\hat{I}}_{v 2} , t , ϵ} [ {‖ ϵ - {𝒢}_{θ} ( {\hat{I}}_{v 2} , t , {ε}_{u} ( {\hat{I}}_{v 1} ) ) ‖}_{2}^{2} ] \qquad ( 1 )$$

where [symbol] _{id} is the identity preserving loss and ∈˜ [symbol] (0, 1).

In Eq. (1) above, the term εᵤ (Îᵥ₁) is used to refer to a preliminary output based on the first training image 1110. The identity preserving loss [symbol] _{id} is computed based on the preliminary output εᵤ (Îᵥ₁) and the second training image 1140.

The image encoder εᵤ and the decoder blocks of diffusion U-Net [symbol] _{θ} are optimized in this process. Intuitively, image encoder 1115 trained for this task can extract representations that are view-invariant while keeping identity-related details that are shared across different views. Unlike conventional view-synthesis models, the first training stage 1100 (also known as context-agnostic identity-preserving stage) is not dependent on any 3-dimensional (3D) information (e.g., camera parameters) as conditions. The first training stage 1100 mainly includes identity preservation instead of geometrical consistency to background (which is handled in the second training stage 1200). Accordingly, only the image encoder 1115 is taken and used in the second training stage 1200.

In an embodiment, image encoder 1115, via a combination of base encoder 1120 and content adapter 1125, generates foreground embedding 1130 (also referred to as an identity-preserving embedding). Foreground embedding 1130 is an example of, or includes aspects of, the corresponding element described with reference to FIG. 12. Diffusion model 1135 takes noise map 1105 and foreground embedding 1130 as inputs. Diffusion model 1135 performs a reverse diffusion process on noise map 1105 and foreground embedding 1130 as described with reference to FIGS. 17 and 19. Diffusion model 1135 is an example of, or includes aspects of, the corresponding element described with reference to FIGS. 10, and 12-15.

FIG. 12 shows an example of an image generation model according to aspects of the present disclosure. The example shown includes second training stage 1200, training background image 1205, training foreground image 1210, image encoder 1215, foreground embedding 1230, diffusion model 1235, input mask 1240, and ground-truth composite image 1245.

FIG. 12 illustrates second training stage 1200 involving training the image generation model 1025 (with reference to FIG. 12) for compositing tasks. The image generation model 1025 includes a fine-tuned image encoder εᵤ and an image generator G_{φ} (parameterized by φ) conditioned on the identity-preserving representations. In some examples, second training stage 1200 includes freezing the backbone of image encoder 1215 in second training stage 1200 and a training set is collected. In some examples, base encoder 1220 (e.g., DINOv2). The base encoder 1220 is kept frozen (i.e., parameters are not updated) at second training stage 1200. Parameters of content adapter 1225 are updated at second training stage 1200.

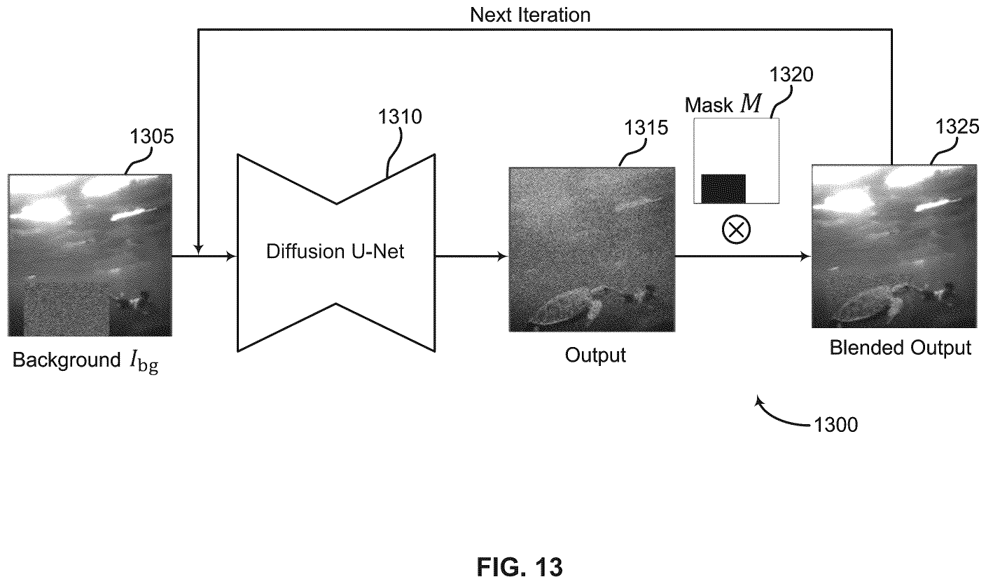

The second training stage 1200 relates to a stage of object compositing. The second training stage 1200 includes a process of taking the learned image encoder 1215 from the first training stage 1100 (see FIG. 11) and freezing the backbone of image encoder 1215. The entire model (including image encoder 1215 and diffusion model 1235) is jointly trained for compositing an object (e.g., a target object in training foreground image 1210) to the masked region indicated in input mask 1240. The input mask 1240 provides size, location and scale information about the object (e.g., a turtle). The input mask 1240 indicates a location of the turtle in relation to the background. An example of a mask blending process is further described in FIG. 13. In some cases, the input mask 1240 is denoted as M.

In some embodiments, a pre-trained text-to-image model is used as the backbone of the image generator. In some cases, diffusion model 1235 takes a background image I_{bg} and coarse mask M as inputs. Diffusion model 1235 is conditioned on an identity-preserving object token Êᵤ=εᵤ(I_{obj}), where I_{obj} indicates a masked object image. The generation is guided by injecting object tokens into the cross-attention layers of [symbol] _{φ}. The coarse mask M is used for the synthesis of shadows, and interactions of the object and the nearby objects. In some cases, I_{obj} is a notation referring to a training foreground image. I_{bg} is a notation referring to a training background image. Êᵤ is a notation referring to foreground embedding 1230.

As Êᵤ already encompasses structured view-invariant details of the object, color and geometric adjustments are not limited by identity preservation efforts. This freedom leads to greater variation in compositing images. In some examples, an objective function of the second training stage 1200 is formulated as:

$${ℒ}_{comp} = {𝔼}_{{i}_{obj} , {I}_{bg}^{*} , M , t , ϵ} [ M {‖ ϵ - {𝒢}_{θ} ( {\hat{I}}_{bg} , t , {\hat{E}}_{u} ) ‖}_{2}^{2} ] \qquad ( 2 )$$

where [symbol] _{comp} is the compositing loss,

$${I}_{bg}^{*}$$

is the target image. [symbol] _{θ} is used to represent U-Net backbone parameterized by θ. Parameters of diffusion U-Net [symbol] _{θ} and the content adapter 1225 are jointly optimized. In some cases, the notation

$${I}_{bg}^{*}$$

is used to refer to a ground-truth composite image.

In Eq. (2) above, the term [symbol] _{θ} (

$${I}_{bg}^{*} ,$$

t, Êᵤ) is referred to as a preliminary composite output. The preliminary composite output is generated based on the training foreground image 1210 and the training background image 1205. The compositing loss [symbol] _{comp} is computed based on the preliminary composite output and the ground-truth composite image. Parameters of the image generation model 1025 (described with reference to FIG. 10) are updated based on the compositing loss [symbol] _{comp}.

In some examples, the background-blending process ensures that the transition area between the object and the background is smooth. The background-blending process is further described in FIG. 13.

Shape-guided controllable compositing enables more practical guidance of the pose and view of the generated object by drawing a rough mask. Accordingly, user control over the composite images is increased. In some examples, masks are defined at four levels of precision (see an example in FIG. 16), where the most coarse mask is a bounding box. Incorporating multiple levels of masks replicates real-world scenarios where users prefer more precise masks.

In one embodiment, image encoder 1215 includes base encoder 1220 and content adapter 1225. Image encoder 1215 is an example of, or includes aspects of, the corresponding element described with reference to FIGS. 10, 11, 14, and 15. Base encoder 1220 is an example of, or includes aspects of, the corresponding element described with reference to FIG. 11. Content adapter 1225 is an example of, or includes aspects of, the corresponding element described with reference to FIGS. 11, 14, and 15.

Foreground embedding 1230 (or referred as the identity-preserving embedding) is an example of, or includes aspects of, the corresponding element described with reference to FIG. 11. Diffusion model 1235 takes training background image 1205 and foreground embedding 1230 as inputs. Diffusion model 1235 generates, via the reserve diffusion process described with reference to FIGS. 17 and 19, a composite image (output image) based on the inputs. In some cases, the output image includes ground-truth composite image 1245 or the output image is compared to ground-truth composite image 1245 to train diffusion model 1235. Diffusion model 1235 is an example of, or includes aspects of, the corresponding element described with reference to FIGS. 10, 11, and 13-15. Input mask 1240 is an example of, or includes aspects of, the corresponding element described with reference to FIGS. 4, 6, and 13-15. In at least FIGS. 11-12 and 14-15, a “snowflake” symbol next to or inside a component is used to indicate that component is not trained or fine-tuned at a training stage (i.e., parameters of that component are not updated). A “fire” symbol next to or inside a component is used to indicate that component is trained or fine-tuned at a training stage (i.e., parameters of that component are to be updated).

FIG. 13 shows an example of background blending process 1300 according to aspects of the present disclosure. The example shown includes background blending process 1300, background image 1305, diffusion model 1310, noise output 1315, input mask 1320, and blended output 1325. In some examples, at each denoising time step, the background area of a denoised latent is masked and blended with unmasked area from the clean background (e.g., the model is constrained to denoise the foreground region).

Background blending process 1300 includes obtaining background image 1305 as input and outputting blended output 1325. In some examples, background image 1305 includes a desired background and a noisy portion of the image (designated by input mask 1320). Background image 1305 is processed through iterative denoising steps performed by a diffusion model 1310. Diffusion model 1310 is an example of, or includes aspects of, the corresponding element described with reference to FIGS. 10-12, 14, and 15. At each iteration, the diffusion model 1310 denoises the entire background image 1305 to generate noise output 1315. An input mask 1320 is then applied to noise output 1315 at a time step, and the masked portion of noise output 1315 is blended with the unmasked area from the original background image 1305 to produce blended output 1325. Blended output 1325 is then fed to the same diffusion model 1310 at a subsequent iteration. Background blending process 1300 smooths the transition area between a foreground object and a background image by denoising the entire composite image, then restoring the original background image at the area indicated by mask 1-M at each time step.

Background image 1305 is an example of, or includes aspects of, the corresponding element described with reference to FIGS. 3-8, 14, 15, and 27. Input mask 1320 is an example of, or includes aspects of, the corresponding element described with reference to FIGS. 4, 6, 12, 14, and 15.

FIG. 14 shows an example of an image generation model 1400 according to aspects of the present disclosure. The example shown includes image generation model 1400, inserted object image 1405, background image 1410, foreground image 1415, image encoder 1420, image tokens 1435, diffusion model 1440, input mask 1445, and composite image 1450. Image generation model 1400 is an example of, or includes aspects of, the corresponding element described with reference to FIGS. 10 and 15.

FIGS. 14-15 show two alternative model architectures that are more intuitive at injecting object features to obtain improved identity preservation. FIG. 14 shows an image generation model 1400 using concatenation. FIG. 15 shows an image generation model 1500 comprising a control network (e.g., ControlNet). To provide extra features, image generation model 1400 and image generation model 1500 use the same segmented object I_{obj} as the additional input. Concatenation and ControlNet result in a spatial correspondence between the output and the additional input (i.e., the generated object tends to have the same size and position as the input). In some cases, using I_{obj} that is much larger than the mask M may have a negative impact on such correspondence. Hence,

$${I}_{obj}^{*}$$

(inserted object image 1405 as the additional hint) is used to provide extra features, where the cropped and resized object I_{obj} is fitted in the mask area of the background image I_{bg}.

In some embodiments, to replace the text encoder branch, image encoder 1420 of image generation model 1400 includes a combination of multi-modal encoder 1425 (e.g., CLIP encoder, ViT-L/14) and content adapter 1430, which are fine-tuned together with the U-Net backbone following the sequential collaborative training method. Furthermore, image generation model 1400 and image generation model 1500 are trained on the same datasets (Pixabay and the video datasets) as the image generation model in the second training stage 1200 (see FIG. 12).

In one embodiment, image encoder 1420 includes multi-modal encoder 1425 and content adapter 1430. Image encoder 1420 is an example of, or includes aspects of, the corresponding element described with reference to FIGS. 10-12, and 15. Multi-modal encoder 1425 is an example of, or includes aspects of, the corresponding element described with reference to FIG. 15. Content adapter 1430 is an example of, or includes aspects of, the corresponding element described with reference to FIGS. 11, 12, and 15.

Image generation model 1400 includes an additional feature injection branch added for the purpose of identity preservation.

$${I}_{obj}^{*}$$

is concatenated with the background image I_{bg}. Accordingly, the U-Net encoder of diffusion model 1440 has 8 channels, where the extra 4 channels are initialized as 0.0 (all zero's) at the beginning of the training. Diffusion model 1440 includes U-Net encoder blocks and U-Net decoder blocks.

Diffusion model 1440 takes inserted object image 1405, background image 1410 and image tokens 1435 as inputs. Diffusion model 1440 generates, via reverse diffusion process with reference to FIGS. 17 and 19, composite image 1450 based on the inputs. Diffusion model 1440 is an example of, or includes aspects of, the corresponding element described with reference to FIGS. 10-13, and 15.

Inserted object image 1405 is an example of, or includes aspects of, the corresponding element described with reference to FIG. 15. Background image 1410 is an example of, or includes aspects of, the corresponding element described with reference to FIGS. 3-8, 13, 15, and 27. Foreground image 1415 is an example of, or includes aspects of, the corresponding element described with reference to FIGS. 3-8, 15, 16, 26, and 27.

Image tokens 1435 is an example of, or includes aspects of, the corresponding element described with reference to FIG. 15. Input mask 1445 is an example of, or includes aspects of, the corresponding element described with reference to FIGS. 4, 6, 12, 13, and 15. Composite image 1450 is an example of, or includes aspects of, the corresponding element described with reference to FIGS. 3-8, and 15.

FIG. 15 shows an example of an image generation model 1500 according to aspects of the present disclosure. The example shown includes image generation model 1500, background image 1505, foreground image 1510, image encoder 1515, image tokens 1530, inserted object image 1535, additional mask input 1540, zero convolutional layer 1545, control network 1550, diffusion model 1555, input mask 1560, and composite image 1565. Image generation model 1500 is an example of, or includes aspects of, the corresponding element described with reference to FIGS. 10 and 14.

Control network 1550 (e.g., ControlNet) can enhance spatial conditioning control, such as depth maps, Canny edges, sketches and human poses. Referring to FIG. 15, the extra inputs are fed into a trainable copy of the original U-Net encoder to learn the condition. For generative object compositing, image generation model 1500 uses the concatenation of the inserted object

$${I}_{obj}^{*}$$

and a mask 1-M indicating the area to generate the object. In the ControlNet branch, the concatenation of

$${I}_{obj}^{*}$$

and a mask are given as the additional input.

In one embodiment, image encoder 1515 includes multi-modal encoder 1520 and content adapter 1525. Image encoder 1515 is an example of, or includes aspects of, the corresponding element described with reference to FIGS. 10-12, and 14. Multi-modal encoder 1520 is an example of, or includes aspects of, the corresponding element described with reference to FIG. 14. Content adapter 1525 is an example of, or includes aspects of, the corresponding element described with reference to FIGS. 11, 12, and 14.

In some examples, image encoder 1515 obtains foreground image 1510 and generates image tokens 1530. The image tokens 1530 are fed to both encoder blocks and decoder blocks of diffusion model 1555.

In some examples, inserted object image 1535 and additional mask input 1540 are fed to zero convolutional layer 1545. The output from zero convolutional layer 1545 is fed to control network 1550.

Background image 1505 is an example of, or includes aspects of, the corresponding element described with reference to FIGS. 3-8, 13, 14, and 27. Foreground image 1510 is an example of, or includes aspects of, the corresponding element described with reference to FIGS. 3-8, 14, 16, 26, and 27.

In some examples, diffusion model 1555 takes background image 1505, image tokens 1530, and output from control network 1550 as inputs. Diffusion model 1555 generates, via reverse diffusion process with reference to FIGS. 17 and 19, composite image 1565 based on the inputs. Diffusion model 1555 is an example of, or includes aspects of, the corresponding element described with reference to FIGS. 10-14.

Image tokens 1530 is an example of, or includes aspects of, the corresponding element described with reference to FIG. 14. Inserted object image 1535 is an example of, or includes aspects of, the corresponding element described with reference to FIG. 14. Input mask 1560 is an example of, or includes aspects of, the corresponding element described with reference to FIGS. 4, 6, and 12-14. Composite image 1565 is an example of, or includes aspects of, the corresponding element described with reference to FIGS. 3-8, and 14.

FIG. 16 shows an example of image compositing based on input masks according to aspects of the present disclosure. The example shown includes foreground image 1600, target image 1605, first mask 1610, second mask 1615, third mask 1620, and fourth mask 1625.

Target image 1605 is generated based on foreground image 1600 and a background image comprising a masked region. First mask 1610 is used to provide information to the image generation model 1025 with reference to FIG. 10 regarding the desired position, size, scale, shape, orientation, and pose of foreground image 1600. Similarly, the second mask 1615, third mask 1620, and fourth mask 1625 provide corresponding guidance information to image generation model 1025.

First mask 1610, second mask 1615, third mask 1620, and fourth mask 1625 are examples of varying degree of coarse levels applied in image composition. Second mask 1615 has an increased coarse level than first mask 1610. The third mask 1620 has an increased coarse level than second mask 1615. Fourth mask 1625 has an increased coarse level than third mask 1620. In some cases, a coarse mask may include a bounding box (e.g., fourth mask 1625 is a bounding box).

As the coarse level increases, image generation model 1025 with reference to FIG. 10 has increased freedom when it generates the target object in a composite image. For example, taking foreground image 1600 and fourth mask 1625 as inputs, image generation model 1025 have greater freedom when generating foreground image 1600 in a composite image. Conversely, inputting first mask 1610 may more accurately represent foreground image 1600 to match target image 1605.

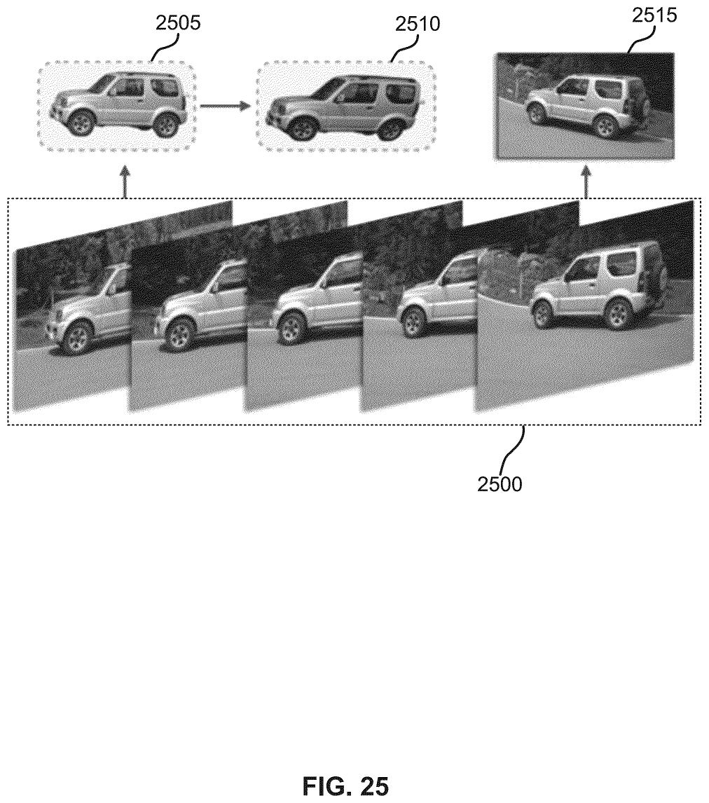

Foreground image 1600 is an example of, or includes aspects of, the corresponding element described with reference to FIGS. 3-8, 14, 15, 26, and 27. Target image 1605 is an example of, or includes aspects of, the corresponding element described with reference to FIG. 25.

FIG. 17 shows an example of a guided latent diffusion model 1700 according to aspects of the present disclosure. The guided latent diffusion model 1700 depicted in FIG. 17 is an example of, or includes aspects of, the corresponding element (i.e., diffusion model 1035) described with reference to FIG. 10.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1700 may take an original image 1705 in a pixel space 1710 as input and apply and image encoder 1715 to convert original image 1705 into original image features 1720 in a latent space 1725. Then, a forward diffusion process 1730 gradually adds noise to the original image features 1720 to obtain noisy features 1735 (also in latent space 1725) at various noise levels.

Next, a reverse diffusion process 1740 (e.g., a U-Net ANN) gradually removes the noise from the noisy features 1735 at the various noise levels to obtain denoised image features 1745 in latent space 1725. In some examples, the denoised image features 1745 are compared to the original image features 1720 at each of the various noise levels, and parameters of the reverse diffusion process 1740 of the diffusion model are updated based on the comparison. Finally, an image decoder 1750 decodes the denoised image features 1745 to obtain an output image 1755 in pixel space 1710. In some cases, an output image 1755 is created at each of the various noise levels. The output image 1755 can be compared to the original image 1705 to train the reverse diffusion process 1740.

In some cases, image encoder 1715 and image decoder 1750 are pre-trained prior to training the reverse diffusion process 1740. In some examples, image encoder 1715 and image decoder 1750 are trained jointly, or the image encoder 1715 and image decoder 1750 and fine-tuned jointly with the reverse diffusion process 1740.

The reverse diffusion process 1740 can also be guided based on a text prompt 1760, or another guidance prompt, such as an image, a layout, a segmentation map, etc. The text prompt 1760 can be encoded using a text encoder 1765 (e.g., a multimodal encoder) to obtain guidance features 1770 in guidance space 1775. The guidance features 1770 can be combined with the noisy features 1735 at one or more layers of the reverse diffusion process 1740 to ensure that the output image 1755 includes content described by the text prompt 1760. For example, guidance features 1770 can be combined with the noisy features 1735 using a cross-attention block within the reverse diffusion process 1740.

FIG. 18 shows an example of U-Net 1800 architecture according to aspects of the present disclosure. In some examples, U-Net 1800 is an example of the component that performs the reverse diffusion process 1740 of guided latent diffusion model 1700 described with reference to FIG. 17 and includes architectural elements of the diffusion model 1035 described with reference to FIG. 10. The U-Net 1800 depicted in FIG. 18 is an example of, or includes aspects of, the architecture used within the reverse diffusion process described with reference to FIG. 17.

In some examples, diffusion models are based on a neural network architecture known as a U-Net. The U-Net 1800 takes input features 1805 having an initial resolution and an initial number of channels and processes the input features 1805 using an initial neural network layer 1810 (e.g., a convolutional network layer) to produce intermediate features 1815. The intermediate features 1815 are then down-sampled using a down-sampling layer 1820 such that down-sampled features 1825 have a resolution less than the initial resolution and a number of channels greater than the initial number of channels.

This process is repeated multiple times, and then the process is reversed. That is, the down-sampled features 1825 are up-sampled using up-sampling process 1830 to obtain up-sampled features 1835. The up-sampled features 1835 can be combined with intermediate features 1815 having the same resolution and number of channels via a skip connection 1840. These inputs are processed using a final neural network layer 1845 to produce output features 1850. In some cases, the output features 1850 have the same resolution as the initial resolution and the same number of channels as the initial number of channels.

In some cases, U-Net 1800 takes additional input features to produce conditionally generated output. For example, the additional input features could include a vector representation of an input prompt. The additional input features can be combined with the intermediate features 1815 within the neural network at one or more layers. For example, a cross-attention module can be used to combine the additional input features and the intermediate features 1815.

FIG. 19 shows an example of diffusion process 1900 according to aspects of the present disclosure. In some examples, diffusion process 1900 describes an operation of the diffusion model 1035 described with reference to FIG. 10, such as the reverse diffusion process 1740 of guided latent diffusion model 1700 described with reference to FIG. 17.

As described above with reference to FIG. 17, using a diffusion model can involve both a forward diffusion process 1905 for adding noise to a media item (or features in a latent space) and a reverse diffusion process 1910 for denoising the media item (or features) to obtain a denoised media item. The forward diffusion process 1905 can be represented as q(xₜ|xₜ₋₁), and the reverse diffusion process 1910 can be represented as p(xₜ₋₁|xₜ). In some cases, the forward diffusion process 1905 is used during training to generate media items with successively greater noise, and a neural network is trained to perform the reverse diffusion process 1910 (i.e., to successively remove the noise).

In an example forward process for a latent diffusion model, the model maps an observed variable x_{T} (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1910, the model begins with noisy data x_{T}, such as a noisy media item 1915 and denoises the data to obtain the p(xₜ₋₁|xₜ). At each step t−1, the reverse diffusion process 1910 takes xₜ, such as first intermediate media item 1920, and t as input. Here, t represents a step in the sequence of transitions associated with different noise levels, The reverse diffusion process 1910 outputs xₜ₋₁, such as second intermediate media item 1925 iteratively until x_{T} reverts back to x₀, the original media item 1930. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) . \qquad ( 3 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) , \qquad ( 4 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

In FIGS. 10-19, an apparatus and method for image processing are described. One or more embodiments of the apparatus and method include at least one processor; at least one memory including instructions executable by the at least one processor; and an image generation model comprising parameters stored in the at least one memory and trained to encode a foreground image to obtain a foreground embedding that preserves an identity of an object in the foreground image and generate a composite image based on a background image and the foreground embedding, wherein the composite image depicts the object from the foreground image within a scene from the background image.

In some examples, the image generation model comprises an image encoder that encodes the foreground image and an image generator that generates the composite image. In some examples, the image encoder comprises a base encoder and a content adapter. In some examples, the image generation model comprises a diffusion U-Net.

### Training and Evaluation

FIG. 20 shows an example of a method 2000 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 2005, the system obtains a first training set including a first training image and a second training image, where the second training image depicts an object from the first training image from a different view. In some cases, the operations of this step refer to, or may be performed by, a training component as described with reference to FIG. 10. In some examples, a first training image and a second training image are denoted as Îᵥ₁ and Îᵥ₂, respectively. The first training image and the second training image include the same object having different views or poses.

At operation 2010, the system trains, using the first training set during a first training stage, an image generation model to generate a synthetic image that preserves an identity and changes an orientation of an object from an input image. In some cases, the operations of this step refer to, or may be performed by, a training component as described with reference to FIG. 10.

In some examples, a diffusion-based generative model (e.g., a diffusion U-Net) is trained via a two-stage training framework that separates the learning of identity preservation from that of object compositing. The first training stage involves context-agnostic, identity-preserving pretraining of an image encoder. The image encoder is trained to learn a foreground embedding that is both view-invariant and conducive to enhanced detail preservation based on the first training set during the first training stage. Details with regard to the first training stage are described in FIG. 11.

In some cases, an image generation model includes an image encoder and a diffusion model. The image encoder includes a base encoder and a content adapter. The diffusion model may be denoted as [symbol] _{θ} and includes a U-Net backbone parameterized by θ. During the first training stage, the image encoder and decoder blocks of the diffusion model are jointly trained (i.e., parameters associated with encoder blocks of the diffusion model are kept frozen). In some examples, a synthetic image is an output from [symbol] _{θ}.

At operation 2015, the system obtains a second training set including a training foreground image, a training background image, and a ground-truth composite image that depicts an object from the training foreground image in a scene from the training background image. In some cases, the operations of this step refer to, or may be performed by, a training component as described with reference to FIG. 10.

The second training stage applies the foreground embedding (or identity-preserving embedding) to learn seamless harmonization of the object composited to the background. In some examples, a shape-guidance mechanism (e.g., a coarse mask) enables user-directed control over the compositing process.

In some examples, a training foreground image, a training background image, and a ground-truth composite image are denoted as

$${I}_{obj} , {I}_{bg} , and {I}_{bg}^{*} .$$

Here, I_{obj} indicates a masked object image.

$${I}_{bg}^{*}$$

is the target image. The image generation model includes the image encoder and the diffusion model. The image encoder includes the base encoder and the content adapter. During the second training stage, the encoder blocks and the decoder blocks of the diffusion model are trained concurrently with the content adapter of the image encoder (i.e., parameters associated with the base encoder are kept frozen). Details with regard to the second training stage are described in FIG. 12.

At operation 2020, the system trains, using the second training set during a second training stage, the image generation model to generate a composite image based on an input foreground image and an input background image, where the composite image depicts an object from the input foreground image in a scene from the input background image. In some cases, the operations of this step refer to, or may be performed by, a training component as described with reference to FIG. 10. In some cases, a composite image may be denoted as Iₒᵤₜₚᵤₜ.

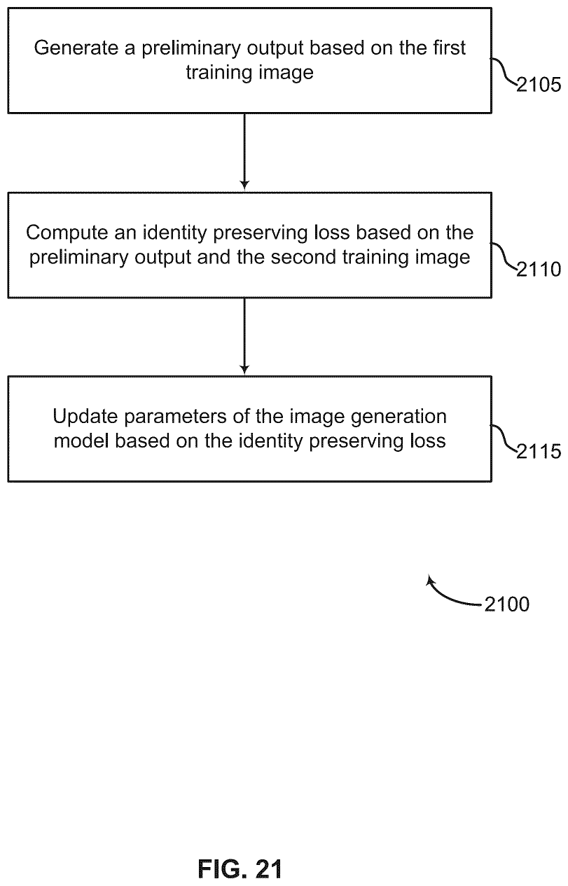

FIG. 21 shows an example of a method 2100 for training an image generation model based on an identity preserving loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 2105, the system generates a preliminary output based on the first training image. In some cases, the operations of this step refer to, or may be performed by, a training component as described with reference to FIG. 10. In some examples, a preliminary output is εᵤ (Îᵥ₁), which is a term in an identity preserving loss. Here, image encoder is denoted as εᵤ while a first training image is denoted as Îᵥ₁.

At operation 2110, the system computes an identity preserving loss based on the preliminary output and the second training image. In some cases, the operations of this step refer to, or may be performed by, a training component as described with reference to FIG. 10. In some examples, an identity preserving loss is denoted as [symbol] _{id}. Detail regarding computing an identity preserving loss is described in FIG. 11.

At operation 2115, the system updates parameters of the image generation model based on the identity preserving loss. In some cases, the operations of this step refer to, or may be performed by, a training component as described with reference to FIG. 10.

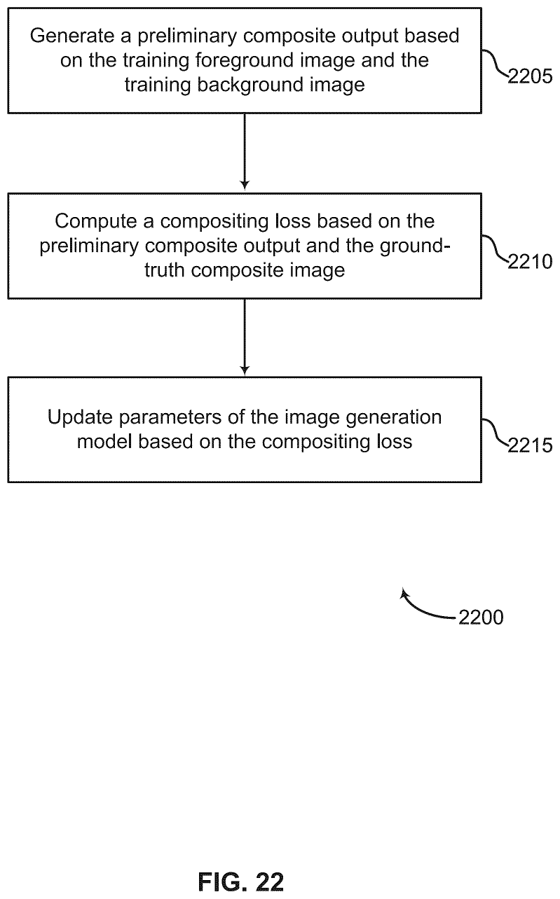

FIG. 22 shows an example of a method 2200 for training an image generation model based on a compositing loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 2205, the system generates a preliminary composite output based on the training foreground image and the training background image. In some cases, the operations of this step refer to, or may be performed by, a training component as described with reference to FIG. 10. In some examples, a preliminary composite output is denoted as [symbol] _{θ}(

$${I}_{bg}^{*} ,$$

t,Êᵤ). A training foreground image is denoted as I_{obj} while a training background image is denoted as I_{bj}.

At operation 2210, the system computes a compositing loss based on the preliminary composite output and the ground-truth composite image. In some cases, the operations of this step refer to, or may be performed by, a training component as described with reference to FIG. 10. In some examples, a compositing loss is denoted as [symbol] comp. A ground-truth composite image is denoted as

$${I}_{bg}^{*} .$$

Detail regarding computing a compositing loss is described in FIG. 12.

At operation 2215, the system updates parameters of the image generation model based on the compositing loss. In some cases, the operations of this step refer to, or may be performed by, a training component as described with reference to FIG. 10.

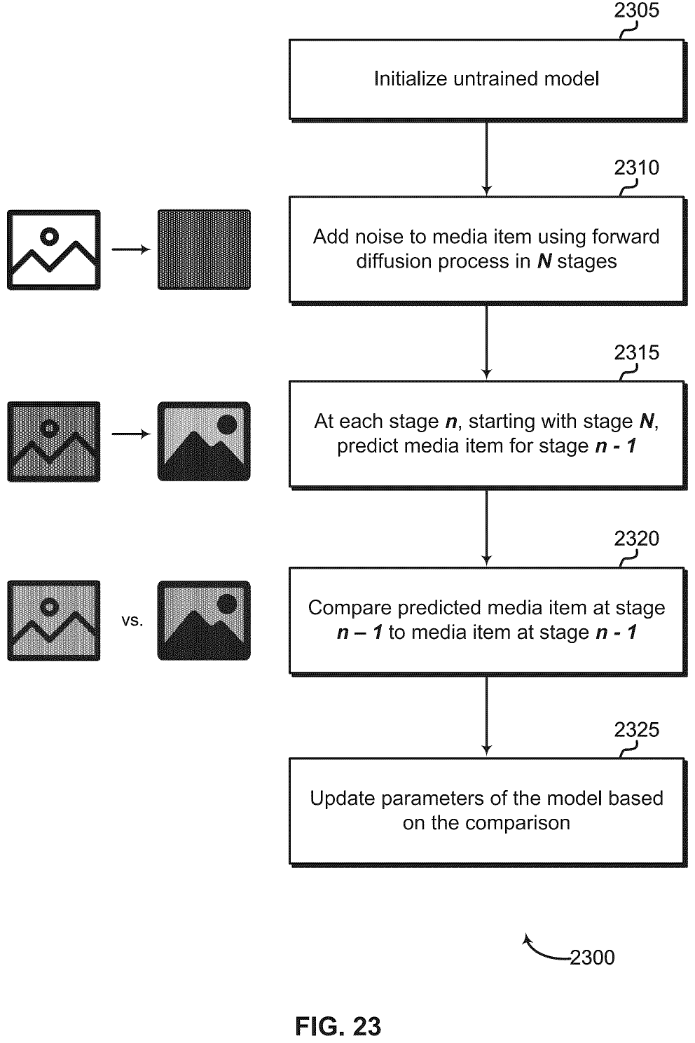

FIG. 23 shows an example of a method 2300 for training a diffusion model according to aspects of the present disclosure. In some embodiments, the method 2300 describes an operation of the training component 1040 described for configuring the image generation model 1025 as described with reference to FIG. 10. The method 2300 represents an example for training a reverse diffusion process as described above with reference to FIGS. 17 and 19. In some examples, these operations are performed by a system including a processor executing a set of codes to control functional elements of an apparatus, such as the guided latent diffusion model described in FIG. 17.

Additionally or alternatively, certain processes of method 2300 may be performed using special-purpose hardware. Generally, these operations are performed according to the methods and processes described in accordance with aspects of the present disclosure. In some cases, the operations described herein are composed of various substeps, or are performed in conjunction with other operations.

At operation 2305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2310, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2315, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2320, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 2325, the system updates parameters of the model based on the comparison. For example, parameters of a U-Net may be updated using gradient descent. Time-dependent parameters of the Gaussian transitions can also be learned.

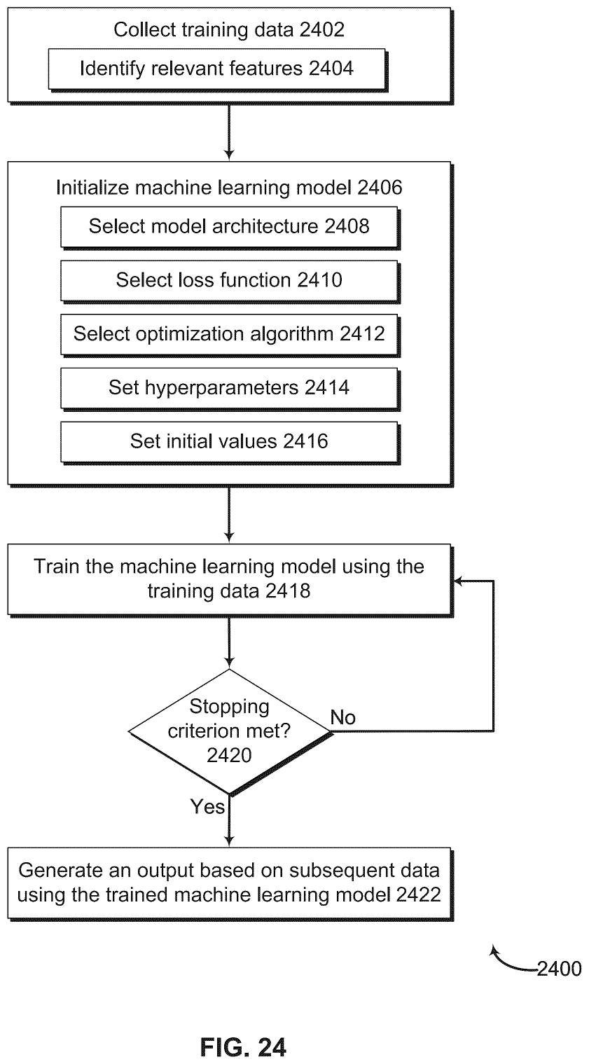

FIG. 24 shows an example of a step-by-step procedure for training a machine learning model according to aspects of the present disclosure. FIG. 24 shows a flow diagram depicting an algorithm as a step-by-step procedure 2400 in an example implementation of operations performable for training a machine-learning model. In some embodiments, the procedure 2400 describes an operation of the training component 1040 described for configuring the image generation model 1025 as described with reference to FIG. 10. The procedure 2400 provides one or more examples of generating training data, use of the training data to train a machine-learning model, and use of the trained machine-learning model to perform a task.

To begin in this example, a machine-learning system collects training data (block 2402) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2406). Initialization of the machine-learning model includes selecting a model architecture (block 2408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2410). The loss function is utilized to measure a difference between an output of the machine-learning model (i.e., predictions) and target values (e.g., as expressed by the training data) to be used to train the machine-learning model. Additionally, an optimization algorithm is selected (2412) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2414) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2420), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2420), the procedure 2400 continues training of the machine-learning model using the training data (block 2418) in this example.

If the stopping criterion is met (“yes” from decision block 2420), the trained machine-learning model is then utilized to generate an output based on subsequent data (block 2422). The trained machine-learning model, for instance, is trained to perform a task as described above and therefore once trained is configured to perform that task based on subsequent data received as an input and processed by the machine-learning model.

FIG. 25 shows an example of data augmentation process according to aspects of the present disclosure. The example shown includes frames 2500, object 2505, augmented object 2510, and target image 2515. Target image 2515 is an example of, or includes aspects of, the corresponding element described with reference to FIG. 16.

Dataset quality is important to obtain improved identity preservation and pose variation. Training an image generation model using multi-view datasets increases the generation fidelity. In some examples, a combination of image datasets (e.g., Pixabay), panoptic video segmentation datasets (e.g., YoutubeVOS, VIPSeg and PPR10K) and object-centric datasets (e.g., MVImgNet and Objaverse) are used. These image datasets are incorporated in different training stages and associated with various processing procedures in the self-supervised training.

The image datasets have high resolution and rich background information, so they are exclusively used in the second training stage for object compositing. To simulate the lighting and geometry changes in object compositing, an augmentation component obtains a preliminary image and applies a transformation or a perturbation to the preliminary image to obtain the training foreground image. Î_{obj}= [symbol] ( [symbol] (I_{obj})), where [symbol] are the affine transformations, and [symbol] is color and light perturbation. The perturbed object Î_{obj} is used as the input and the natural image

$${I}_{bg}^{*}$$

containing the original object is used as the target.

Video segmentation datasets may suffer from low resolution and motion blur, which harm the generation quality. But video segmentation datasets provide object pairs which naturally differ in lighting, geometry, view and provide non-rigid pose variations. In some cases, video segmentation datasets are used in the second training stage. Referring to FIG. 25, each training pair comes from one video with instance-level segmentation labels. Two distinct frames are randomly sampled (e.g., two frames are randomly sampled from frames 2500); one frame serves as the target image 2515, while an object 2505 is extracted from the other frame as the augmented input (i.e., augmented object 2510).

Object-centric datasets provide a larger scale than video segmentation datasets and more intricate object details. But object-centric datasets are exclusively used in the first training stage due to the limited background information available in these datasets. During training, each pair Iᵥ₁, Iᵥ₁ are also randomly sampled from the same video with |v1−v2|≤n, where n is the temporal sampling window. Empirically, generation quality decreases as n increases, and n=7 strikes a balance between fidelity and quality.

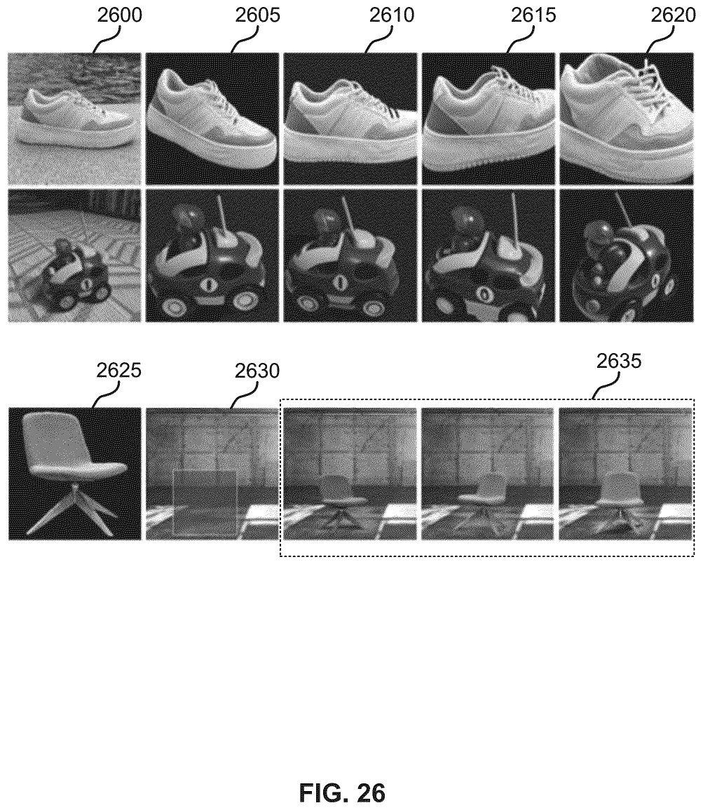

FIG. 26 shows an example of data curation and view pose adjustment according to aspects of the present disclosure. The example shown includes foreground image 2600, first sample 2605, second sample 2610, third sample 2615, and fourth sample 2620. The example shown also includes additional object 2625, additional background image 2630, and output images 2635.

In some examples, an image generation model is trained under context-agnostic identity-preserving stage (i.e., first training stage 1100 as shown in FIG. 11). Taking foreground image 2600 as input, the image generation model generates view pose changes while learning the details of the object (e.g., “shoe” object) from foreground image 2600. First sample 2605, second sample 2610, third sample 2615, and fourth sample 2620 are examples of view pose changes generated using the image generation model based on foreground image 2600. Foreground image 2600 is an example of, or includes aspects of, the corresponding element described with reference to FIGS. 3-8, 14-16, and 27.

In some examples, the image generation model generates view pose changes while memorizing the details of additional object 2625 (e.g., a “chair” object). The bottom row shows diverse poses and orientation of additional object 2625 (e.g., the chair) within a scene of additional background image 2630. The image generation model generates output images 2635 after the model has been trained via second training stage 1200 described with reference to FIG. 12.

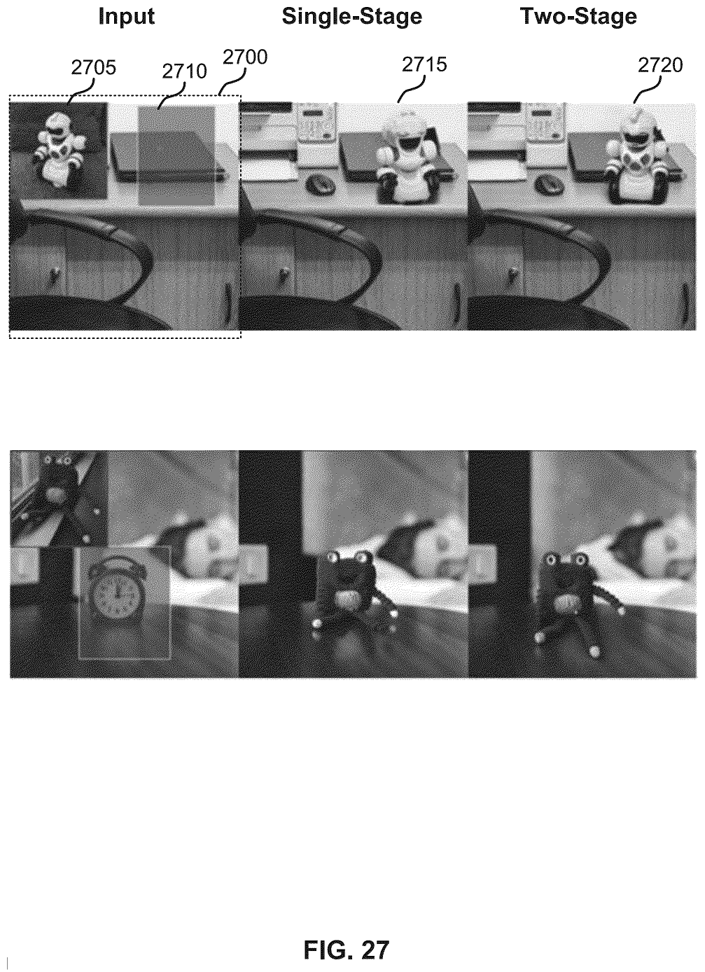

FIG. 27 shows an example of ablation study on two-stage training process according to aspects of the present disclosure. The example shown includes background image 2700, foreground image 2705, masked region 2710, first composite image 2715, and second composite image 2720. In some examples, inputs to a machine learning model (e.g., image generation model 1025) includes background image 2700, foreground image 2705, and masked region 2710. The masked region 2710 indicates a location and a scale for an object in foreground image 2705. An example of the object is a robot. In some cases, the masked region 2710 includes a bounding box.

FIG. 27 illustrates an ablation study on the two-stage training scheme described in FIGS. 11-12 and 20. In a single-stage training setting, MVImgNet dataset is added to the training set and the entire model is trained in one stage. Compared with two-stage training described in FIGS. 11-12 and 20, single-stage training leads to degradation in quality and loss of details. Without the first training stage 1100 (see FIG. 11), the compositing quality is decreased.

Referring to an example of FIG. 27, first composite image 2715 is generated using a model trained in a single stage. The second composite image 2720 is generated using the image generation model trained in two stages, i.e., first training stage 1100 and second training stage 1200 with reference to FIGS. 11-12.

Background image 2700 is an example of, or includes aspects of, the corresponding element described with reference to FIGS. 3-8, and 13-15. Foreground image 2705 is an example of, or includes aspects of, the corresponding element described with reference to FIGS. 3-8, 14-16, and 26. Masked region 2710 is an example of, or includes aspects of, the corresponding element described with reference to FIGS. 3, 5, 7, and 8.

In FIGS. 20-27, a method, apparatus, and non-transitory computer readable medium for image processing are described. One or more embodiments of the method, apparatus, and non-transitory computer readable medium include obtaining a first training set including a first training image and a second training image, wherein the second training image depicts an object from the first training image from a different view; training, using the first training set during a first training stage, an image generation model to generate a synthetic image that preserves an identity and changes an orientation of an object from an input image; obtaining a second training set including a training foreground image, a training background image, and a ground-truth composite image that depicts an object from the training foreground image in a scene from the training background image; and training, using the second training set during a second training stage, the image generation model to generate a composite image based on an input foreground image and an input background image, wherein the composite image depicts an object from the input foreground image in a scene from the input background image.

Some examples of the method, apparatus, and non-transitory computer readable medium further include generating a preliminary output based on the first training image. Some examples further include computing an identity preserving loss based on the preliminary output and the second training image. Some examples further include updating parameters of the image generation model based on the identity preserving loss.

Some examples of the method, apparatus, and non-transitory computer readable medium further include initializing the image generation model using parameters of a pre-trained base model. Some examples further include freezing an encoder layer of the image generation model during the first training stage.

Some examples of the method, apparatus, and non-transitory computer readable medium further include training the encoder layer of the image generation model during the second training stage.

Some examples of the method, apparatus, and non-transitory computer readable medium further include generating a preliminary composite output based on the training foreground image and the training background image. Some examples further include computing a compositing loss based on the preliminary composite output and the ground-truth composite image. Some examples further include updating parameters of the image generation model based on the compositing loss.

Some examples of the method, apparatus, and non-transitory computer readable medium further include freezing an image encoder of the image generation model during the second training stage.

Some examples of the method, apparatus, and non-transitory computer readable medium further include training the image encoder of the image generation model during the first training stage.

Some examples of the method, apparatus, and non-transitory computer readable medium further include obtaining a video. Some examples further include extracting the first training image from a first frame of the video and the second training image from a second frame of the video.

Some examples of the method, apparatus, and non-transitory computer readable medium further include obtaining a preliminary image. Some examples further include applying a transformation or a perturbation to the preliminary image to obtain the training foreground image.

FIG. 28 shows an example of a computing device 2800 for image processing according to aspects of the present disclosure. The computing device 2800 may be an example of the image generation apparatus 1000 described with reference to FIG. 10. In one aspect, computing device 2800 includes processor(s) 2805, memory subsystem 2810, communication interface 2815, I/O interface 2820, user interface component(s) 2825, and channel 2830.

In some embodiments, computing device 2800 is an example of, or includes aspects of, the image generation model of FIG. 10. In some embodiments, computing device 2800 includes one or more processors 2805 that can execute instructions stored in memory subsystem 2810 to perform media generation.

According to some aspects, computing device 2800 includes one or more processors 2805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2815 operates at a boundary between communicating entities (such as computing device 2800, one or more user devices, a cloud, and one or more databases) and channel 2830 and can record and process communications. In some cases, communication interface 2815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2820 is controlled by an I/O controller to manage input and output signals for computing device 2800. In some cases, I/O interface 2820 manages peripherals not integrated into computing device 2800. In some cases, I/O interface 2820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2820 or via hardware components controlled by the I/O controller.

According to some aspects, user interface component(s) 2825 enable a user to interact with computing device 2800. In some cases, user interface component(s) 2825 include an audio device, such as an external speaker system, an external display device such as a display screen, an input device (e.g., a remote-control device interfaced with a user interface directly or through the I/O controller), or a combination thereof. In some cases, user interface component(s) 2825 include a GUI.

Performance of apparatus, systems and methods of the present disclosure have been evaluated, and results indicate embodiments of the present disclosure have obtained increased performance over existing technology. Example experiments demonstrate that the image generation apparatus described in embodiments of the present disclosure outperforms conventional systems. Example experiments demonstrate that image generation model 1025 with reference to FIG. 10 outperforms existing methods and baselines on identity preservation and composition quality.

Some embodiments of the present disclosure include a context-agnostic identity-preserving training scheme and example experiments can demonstrate superior appearance preservation through comprehensive experiments. The two-stage training framework (described with reference to FIGS. 11-12) separates the tasks of identity preservation and background alignment, enabling realistic compositing effects. Some embodiments incorporate mask control into image generation model 1025 (described with reference to FIGS. 11-13), enhancing shape guidance and generation flexibility. Example experiments include extensive study on appearance retention, providing insights into different factors influencing identity preservation, e.g., image encoders, multi-view datasets, training methods, etc.

Image generation model 1025, after training, achieves improved performance on a combination of identity preservation and image compositing. At inference time, an object is to be altered in terms of color, lighting, and geometry, to better align with the background. Simultaneously, the object's original pose, color tone, and illumination effects are memorized by image generation model 1025 (its appearance).

Conventional training-free methods use a frozen transformer-based image encoder. However, freezing the encoder can prohibit conventional models from extracting the object details. Unlike conventional methods, embodiments of the present disclosure fine-tune an image encoder specifically for compositing, ensuring the extraction of instance-level features.

In some embodiments, sequential collaborative training is used to avoid overfitting, effectively stabilize the training process, and improve identity preservation. In some examples, the object compositing stage is divided into two phases. In the first n epochs, assign the adapter a larger learning rate of 4×10⁻⁵ and assign the U-Net a smaller learning rate of 4×10⁻⁶. In the next n epochs, swap the learning rate of the two components (and the training finishes). This method focuses on training one component at each phase, with the other component simultaneously trained at a lower rate to adapt to the changed domain. The image generator is trained in the end to ensure image synthesis quality.

Referring to FIG. 11, as an example, the first training stage 1100 is trained on 1,409,545 pairs and validated on 11,175 pairs from MVImgNet, which takes 5 epochs to finish. The learning rate associated with DINOv2 (ViT-g/14 with registers) is 4×10⁻⁶, and the batch size is 256. The image embedding is dropped at a rate of 0.05. Referring to FIG. 12, as an example, the second training stage 1200 is fine-tuned on a mixture of image datasets and video datasets, including a training set of 217,451 pairs and a validation set of 15,769 pairs, where segmentation masks are obtained as labels. It is trained for 15 epochs with a batch size of 256. The embedding is dropped at a rate of 0.1. In both training stages, the images are resized to 512×512. During inference, the DDIM sampler generates the composite image after 50 denoising steps using a classifier-free guidance (CFG) scale of 3.0. In some examples, the model is trained on 8 NVIDIA A100 GPUs and includes Stable Diffusion v1.4.

In some examples, datasets are collected from Pixabay and DreamBooth for testing the model. Pixabay testing set has 1,000 high-resolution images and has no overlap with the training set. A foreground object is selected from each image and perturbed through the data augmentation process described with reference to FIG. 25. The DreamBooth testing set has 25 unique objects with various views. Combined with 59 background images that are manually chosen, 113 pairs are generated for this testing set. This dataset is challenging since most objects are of complex texture or structure.

Metrics measuring fidelity and realism are used to evaluate the effectiveness of different models in terms of identity preservation and background harmonization. In some cases, CLIP-score, DINO-score, and DreamSim are used or applied to measure generation fidelity. To obtain precise comparison results, output images are cropped so that the generated object is located in the center of the image. Fréchet inception distance (FID) is employed to measure the realism which indicates the compositing quality.

As example experiments have shown, the two-stage training framework has obtained increased performance in identity preservation and background harmonization for generative object compositing. The two-stage training framework enables the image generation model 1025 to learn a view-invariant, identity-preserving representation that efficiently captures the details of the object. By separating the task into an identity preserving stage (the first training stage 1100) and a harmonization stage (the second training stage 1200), the image generation model 1025 generates large color and geometry variations to better align with the background. Through visual and numerical comparison results, the model outperforms conventional models and methods. Additionally, shape guidance is added to further increase user control.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a foreground image and a background image, wherein the foreground image depicts an object and the background image depicts a scene;
encoding, using an image encoder of an image generation model, the foreground image to obtain a foreground embedding, wherein the foreground embedding preserves an identity of the object; and
generating, using the image generation model, a composite image based on the background image and the foreground embedding, wherein the composite image depicts the object from the foreground image within the scene from the background image.

2. The method of claim 1, wherein obtaining the foreground image comprises:
obtaining a preliminary image; and
removing a background from the preliminary image to obtain the foreground image.

3. The method of claim 1, wherein:
the background image comprises a masked region indicating a location and a scale for the object.

4. The method of claim 1, wherein generating the composite image comprises:
obtaining an input mask indicating a location of the object in the scene, wherein the composite image is generated based on the input mask.

5. The method of claim 1, wherein generating the composite image comprises:
obtaining a noise map; and
denoising the noise map based on the foreground embedding.

6. The method of claim 5, wherein:
the noise map is generated based on the background image.

7. The method of claim 1, wherein:
the image encoder is trained to preserve an object identity during a first training stage and wherein the image encoder and a decoder of the image generation model are trained to combine images during a second training stage.

8. A method of training an image generation model, the method comprising:
obtaining a first training set including a first training image and a second training image, wherein the second training image depicts an object from the first training image in a different view;
training, using the first training set during a first training stage, an image generation model to generate a synthetic image that preserves an identity and changes an orientation of an object from an input image;
obtaining a second training set including a training foreground image, a training background image, and a ground-truth composite image that depicts an object from the training foreground image in a scene from the training background image; and
training, using the second training set during a second training stage, the image generation model to generate a composite image based on an input foreground image and an input background image, wherein the composite image depicts an object from the input foreground image in a scene from the input background image.

9. The method of claim 8, wherein training the image generation model during the first training stage comprises:
generating a preliminary output based on the first training image;
computing an identity preserving loss based on the preliminary output and the second training image; and
updating parameters of the image generation model based on the identity preserving loss.

10. The method of claim 8, wherein training the image generation model during the first training stage comprises:
initializing the image generation model using parameters of a pre-trained base model; and
freezing an encoder layer of the image generation model during the first training stage.

11. The method of claim 10, wherein training the image generation model during the second training stage comprises:
training the encoder layer of the image generation model during the second training stage.

12. The method of claim 8, wherein training the image generation model during the second training stage comprises:
generating a preliminary composite output based on the training foreground image and the training background image;
computing a compositing loss based on the preliminary composite output and the ground-truth composite image; and
updating parameters of the image generation model based on the compositing loss.

13. The method of claim 8, wherein training the image generation model during the second training stage comprises:
freezing an image encoder of the image generation model during the second training stage.

14. The method of claim 13, wherein training the image generation model during the first training stage comprises:
training the image encoder of the image generation model during the first training stage.

15. The method of claim 8, wherein obtaining the second training set comprises:
obtaining a video; and
extracting the first training image from a first frame of the video and the second training image from a second frame of the video.

16. The method of claim 8, wherein obtaining the second training set comprises:
obtaining a preliminary image; and
applying a transformation or a perturbation to the preliminary image to obtain the training foreground image.

17. An apparatus comprising:
at least one processor;
at least one memory including instructions executable by the at least one processor; and
an image generation model comprising parameters stored in the at least one memory and trained to encode a foreground image to obtain a foreground embedding that preserves an identity of an object in the foreground image and generate a composite image based on a background image and the foreground embedding, wherein the composite image depicts the object from the foreground image within a scene from the background image.

18. The apparatus of claim 17, wherein:
the image generation model comprises an image encoder that encodes the foreground image and an image generator that generates the composite image.

19. The apparatus of claim 18, wherein:
the image encoder comprises a base encoder and a content adapter.

20. The apparatus of claim 17, wherein:
the image generation model comprises a diffusion U-Net.
